(19) United States
(12) Patent Application Publication
(10) Pub. No.: US 2026/0213806 A1
(43) Pub. Date: Jul. 23, 2026

(54) ENHANCED PROPAGATION CONDITION-AWARE MODEL CONFIGURATION IN AUTOENCODER-BASED CHANNEL STATE INFORMATION FEEDBACK FOR WIRELESS COMMUNICATIONS

(71) Applicant: INTEL CORPORATION, Santa Clara, CA (US)

(72) Inventors: Shuang YAO, Beaverton, OR (US); Dawei YING, Portland, OR (US); Qian LI, Portland, OR (US)

(73) Assignee: INTEL CORPORATION, Santa Clara, CA (US)

(21) Appl. No.: 19/140,345

(22) PCT Filed: Dec. 15, 2023
(86) PCT No.: PCT/US2023/084408

§ 371 Date: Jun. 17, 2025

Related U.S. Application Data
(60) Provisional application No. 63/439,339, filed on Jan. 17, 2023.

(51) Int. Cl. H04B 7/06

(52) U.S. Cl. CPC H04B 7/0626; H04B 7/063; H04B 7/0639

(57) ABSTRACT

This disclosure describes systems, methods, and devices for adjusting encoder model and encoder output configuration. A user equipment (UE) device may select an encoder model based on the propagation condition; select an encoder output configuration based on the propagation condition; encode, using the encoder model and the encoder output configuration, CSI feedback indicative of the channel state information; and provide, the encoded CSI feedback and an assistance data that reflects the propagation condition and is used to select the encoder model and the encoder output configuration to a base station.

### CROSS-REFERENCE TO RELATED PATENT APPLICATION(S)

This application claims the benefit of U.S. Provisional Application No. 63/439,339, filed Jan. 17, 2023, the disclosure of which is incorporated herein by reference as if set forth in full.

### TECHNICAL FIELD

This disclosure generally relates to systems and methods for wireless communications and, more particularly, to propagation condition-aware model configurations in autoencoder-based channel state information feedback.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating an example network environment, in accordance with one or more example embodiments of the present disclosure.

FIG. 2 is an example process for propagation condition-aware encoder model and encoder output configuration adaptation, in accordance with one or more example embodiments of the present disclosure.

FIG. 3 illustrates a flow diagram of illustrative process for adjusting encoder model and encoder output configuration, in accordance with one or more example embodiments of the present disclosure.

FIG. 4. illustrates a network, in accordance with one or more example embodiments of the present disclosure.

FIG. 5 schematically illustrates a wireless network, in accordance with one or more example embodiments of the present disclosure.

FIG. 6 is a block diagram illustrating components, in accordance with one or more example embodiments of the present disclosure.

FIG. 7 illustrates a network, in accordance with one or more example embodiments of the present disclosure.

FIG. 8 illustrates a simplified block diagram of artificial (AI)-assisted communication between a user equipment and a radio access network, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3^{rd} Generation Partnership Program (3GPP) define communication techniques, including for multiple-input multiple-output (MIMO) communications. MIMO communications increase data throughput (e.g., compared to single input single output) by using multiple transmitter antennae and multiple receiver antennae at a same user device or network node. In MIMO, multiple independent data streams (e.g., in contrast with sending a copy of a bit stream to multiple receiver antennae) may be transmitted simultaneously by one user device.

To fully exploit the advantage of MIMO, accurate channel state information (CSI) is required. The 3GPP standards define CSI such as channel quality information, precoding matrix indicators, CSI resource indicators, spatial stream/physical broadcast channel resource indicators, layer indicators, and rank indicators. Downlink CSI is obtained at the user equipment (UE) and sent to the base station (BS). To achieve high accuracy CSI feedback with limited overhead, a two-sided autoencoder-based machine learning (ML) model may be implemented, in which an encoder compresses the CSI at the UE, and a decoder decompresses the CSI at the BS based on the compressed information received from the UE. This compression/decompression process refers to use of an autoencoder to send and receive CSI feedback between devices. The decoder at the receiving side needs to pair with the encoder at the sending side to ensure that the data compressed with the encoder can be decompressed by the decoder.

Existing autoencoder-based solutions for CSI feedback apply a same encoder model and the same encoder output configuration with a fixed feedback overhead to all UEs served by a same BS. However, such an approach fails to consider the non-uniform difficulty of CSI compression among UEs, especially when the UEs experience various propagation conditions.

The present disclosure therefore proposes a mechanism to select an encoder model (e.g., from among multiple available encoder models) as well as an encoder output configuration (e.g., from among multiple available encoder output configurations) based on a UE's propagation condition. An autoencoder configuration policy is defined by BS and signaled to UE, which specifies a set of rules of selecting encoder model and encoder output configuration according to UE's propagation condition. In the CSI report, apart from encoded CSI, UE also sends assistance data regarding propagation condition that it utilizes when determining the encoder model and the encoder output configuration, so that BS can adjust decoder correspondingly and decode CSI successfully. In this manner, the autoencoder may be adaptable to a propagation condition. The BS may configure the autoencoder configuration policy that the UE is to apply, which defines the rules for selecting which encoder model and which encoder output configuration to use based on a propagation condition. Current techniques do not allow for adjusting the encoder model and/or encoder output configuration based on propagation conditions, and they do not provide signaling from the BS to instruct the UE in this manner.

To allow the autoencoder to be adaptable, the UE and the BS both need to be aware of which encoder model and which encoder output configuration the UE is applying for a given CSI feedback transmission. This challenge does not exist in a static autoencoder situation in which the autoencoder does not change. The autoencoder configuration policy set by the BS and signaled to the UE allows the UE to adjust the autoencoder based on channel conditions. The UE may signal its channel condition to the BS so that the BS may determine which autoencoder (e.g., which encoder model and which encoder output configuration) is being applied at the UE side to the CSI feedback.

CSI (including the precoder matrix indicator (PMI), channel quality indicator (CQI), etc.) plays an important role in achieving high throughput and interference management. In addition to continued efforts of improving codebook design, enhancing CSI feedback with AI/ML models has been listed as a use case in 3GPP release 18. One of the ML models for CSI feedback is an autoencoder. It is two-sided model: there is one encoder at the UE to compress the CSI, and one decoder at the BS to decompress the CSI. Considering that the UEs served by the same BS experience a wide range of propagation conditions, it is not an efficient solution to deploy a single uniform encoder model and a fixed encoder output configuration at all UEs. For line-of-sight (LOS) UEs, it would be a waste of bandwidth if their encoder output configuration generates CSI feedback with large feedback overhead, or power-inefficient if a complicated encoder model is utilized. On the other hand, for non LOS (NLOS) UEs, an encoder output configuration with a small feedback overhead or simplified encoder model can lead to a poor CSI feedback accuracy and finally a degradation in throughput. Thus, the present disclosure provides a mechanism to adapt encoder model and encoder output configuration to UE's experienced propagation condition.

Some autoencoder solutions use a pre-processing step in which a channel matrix in the frequency space domain H is converted to the angular-delay domain H_{AD} through fast Fourier transform (FFT). The dimension of the channel matrix is N_{f}×Nₜ, where N_{f} is the number of samples in the frequency domain and Nₜ is the total number of antenna ports in two polarizations. Due to the sparsity in the delay domain, only N_{d} rows are extracted and used as input to the autoencoder. At the encoder, the channel matrix is processed sequentially by a convolutional layer, a batch normalization (BN) layer and a fully connected (FC) layer. At the decoder, the CSI codeword is first processed by a FC layer, and then sent into two refining units connected in series. In the refining unit, there are convolutional layers with each convolutional layer followed by a BN layer, plus an identity shortcut. The numbers of feature maps in the first two convolutional layers may be denoted as C₁ and C₂, respectively.

In one or more embodiments, LOS/NLOS state is available to UE. UE can directly use this information as the assistance data that reflects propagation condition to adapt encoder model and encoder output configuration. For LOS UE, an increase in N_{d} leads to negligible improvement, while for NLOS UE, the 10^{th} percentile of spectrum efficiency (SE) increases by 0.54 bits/s/Hz. When C₁ and C₂ increase from 1 and 2 to 8 and 16, although this change brings about minimal improvement to LOS UE, it proves to be beneficial to NLOS UE, whose 10^{th} percentile of SE increases by 0.40 bits/s/Hz. When the encoder output configuration changes to yield a CSI feedback overhead increase from 32 bits to 256 bits, the 10^{th} percentile of SE of NLOS UEs increases by 1.20 bits/s/Hz, yet the improvement of LOS UE is trivial.

In another embodiment, the LOS/NLOS state is not available at UE. The present disclosure therefore defines another quantity to act as a proxy of LOS/NLOS state and to be used as the assistance data that reflects propagation condition to adapt encoder model and encoder output configuration. As noted above, channel matrices are usually sparse in the delay domain, i.e., large values are concentrated in a few delay bins. Moreover, the sparsity in the delay domain is highly related with propagation condition, e.g., high sparsity is often observed at LOS UEs. Therefore, contrast ratio (CR) of the channel matrix in the angular-delay domain is used as a quantity to estimate propagation condition, which is defined as:

$$CR = \frac{{max}_{1 \leq i \leq {N}_{f}} \frac{1}{{N}_{t}} {\sum }_{j = 1}^{{N}_{t}} \vert {H}_{AD} ( i , j ) \vert}{{min}_{1 \leq i \leq {N}_{f}} \frac{1}{{N}_{t}} {\sum }_{j = 1}^{{N}_{t}} \vert {H}_{AD} ( i , j ) \vert} .$$

NLOS UEs have smaller CR than LOS UEs. The performance of different encoder models and encoder output configurations may be compared and the UEs may be split into two groups based on their CRs. In one embodiment, high CR UEs refer to the UEs with CR higher than a threshold (e.g., 48 dB, 45 dB, or another number), while low CR UEs refer to the UEs with CR less or equal to a threshold (e.g., 48 dB, 45 dB, or another number). Similar to an embodiment described above, applying a more complicated encoder model or an encoder output configuration with larger feedback overhead can improve the performance of low CR UEs, while the improvement is tiny for high CR UEs.

In one or more embodiments, for the autoencoder configuration policy procedure, the BS indicates that it can support autoencoder-based CSI feedback (e.g., via SIB broadcast). The BS queries UE capability of autoencoder-based CSI feedback as well as availability of assistance data regarding propagation condition, i.e., LOS/NLOS state and CR. The UE reports to BS its capability of autoencoder-based CSI feedback such as model size budget, memory budget, and availability of assistance data regarding propagation condition. According to UE's capability of autoencoder-based CSI feedback and availability of assistance data regarding propagation condition, BS configures one autoencoder configuration policy or a set of autoencoder configuration policies and send to UEs via RRC CSI-AutoencoderConfigPolicy, whose description is defined below.

After configuring autoencoder configuration policy (or policies), BS sends encoder model(s) as defined by the autoencoder configuration policy (or policies). It is up to BS to decide whether to apply different encoder models for different propagation conditions and the decision process is out of scope of the present disclosure. UE deploys autoencoder configuration policy (or policies) and encoder model(s). If there is only one autoencoder configuration policy configured by BS, this policy is applied to all autoencoder-based CSI reports. If there is more than one autoencoder configuration policy configured by BS, BS specifies an autoencoder configuration policy for each autoencoder-based CSI report. To this end, a new field, autoencoderConfigPolicyId, is added to the CSI-ReportConfig and its definition will be defined.

After receiving CSI-RS, UE utilizes the assistance data regarding propagation condition, e.g., LOS/NLOS state or CR to select the encoder model and the encoder output configuration and encodes CSI. In the CSI report, a new field, assistanceData, is added to indicate the assistance data regarding propagation condition that is utilized by UE when selecting the encoder model and the encoder output configuration, to assist BS to apply the correct decoder model to decode CSI.

In one or more embodiments, for the autoencoder configuration policy itself, the following information elements (IEs) are defined:

A CSI-AutoencoderConfigPolicy IE specifies the autoencoder configuration policy (or policies), including an ID of the autoencoder configuration policy, and a list of autoencoder configurations:

-- ASN1START
-- TAG-CSI-AUTOENCODERCONFIGPOLICY-START

| | |
|---|---|
| CSI-AutoencoderConfigPolicy ::= | SEQUENCE { |
| autoencoderConfigPolicyId | AutoencoderConfigPolicyId, |
| autoencoderConfigList | SEQUENCE (size |

(1..maxNrofAutoencoderConfigList)) of AutoencoderConfig
}
-- TAG-CSI-AUTOENCODERCONFIGPOLICY-STOP
-- ASN1STOP

autoencoderConfigPolicyId assigns an ID to each policy, which can be used in the CSI-ReportConfig to refer to an autoencoder configuration policy:

-- ASN1START
-- TAG-AUTOENCODERCONFIGPOLICYID-START

| | |
|---|---|
| AutoencoderConfigPolicyId ::= | INTEGER (0..maxNrofAutoencoderPolicyConfig |

- 1)
-- TAG-AUTOENCODERCONFIGPOLICYID-STOP
-- ASN1STOP

autoencoderConfigList is a list of autoencoder configurations AutoencoderConfig:

| -- ASN1START | |
|---|---|
| -- TAG-AUTOENCODERCONFIG-START | |
| AutoencoderConfig ::= | SEQUENCE { |
| assistanceData | AssistanceData, |
| encModId | EncModId, |
| encOuputConfig | EncOutputConfig |

}
-- TAG-AUTOENCODERCONFIG-STOP
-- ASN1STOP

AutoencoderConfig has three fields: assistanceData, encModId and encOutputConfig.

The assistance Data field descriptions are as follows: the content of the assistanceData field specifies a propagation condition defined by an assistance data that the encoder model and encoder output configuration should be applied. The assistanceData field is of data type AssistanceData. AssistanceData IE is as follows:

| -- ASN1START | |
|---|---|
| -- TAG-ASSISTANCEDATA-START | |
| AssistanceData ::= | CHOICE { |
| los-NLOS-state | LOS-NLOS-State, |
| cr-Range | CR-Range |

}
-- TAG-ASSISTANCEDATA-STOP
-- ASN1STOP

The content of AssistanceData is one of these IEs:
LOS-NLOS-State
CR-Range

LOS-NLOS-State IE provides the information on whether the link between UE and BS is LOS or NLOS. It can be a hard value indicating LOS (e.g., TRUE) or NLOS (e.g., FALSE), or an interval of soft value indicating the probability of the link being LOS.

The LOS-NLOS-State IE is as follows:

| -- ASN1START | |
|---|---|
| -- TAG-LOS-NLOS-STATE-START | |
| LOS-NLOS-state ::= | CHOICE { |
| hard-LOS-NLOS-State | BOOLEAN, |
| soft-LOS-NLOS-Range | Soft-LOS-NLOS-Range |

}
-- TAG-LOS-NLOS-STATE-STOP
-- ASN1STOP

The LOS-NLOS-State field description is as follows. The content has two choices:
hard-LOS-NLOS-State: a hard value describing the link to be LOS (TRUE) or NLOS (FALSE)
soft-LOS-NLOS-Range: an interval of soft value describing the probability of the link being LOS.

The Soft-LOS-NLOS-Range IE is as follows:

-- ASN1START
-- TAG-SOFT-LOS-NLOS-RANGE-START

| | |
|---|---|
| Soft-LOS-NLOS-Range ::= | SEQUENCE { |
| soft-LOS-NLOS-Range-Id | INTEGER (0..maxNrofSoft-LOS-NLOS- |

Range - 1),

| | |
|---|---|
| soft-LOS-NLOS-Range-LowBound | INTEGER (0..10), |
| soft-LOS-NLOS-Range-UpBound | INTEGER (0..10) |

}
-- TAG-SOFT-LOS-NLOS-RANGE-STOP
-- ASN1STOP

Soft-LOS-NLOS-Range defines a soft LOS/NLOS state interval that a specific encoder model and a specific encoder output configuration applies. The field soft-LOS-NLOS-Range-Id assigns an ID to each soft LOS/NLOS state interval that can be used in the CSI report.

Table 1 below shows the Soft-LOS-NLOS-Range field descriptions:

TABLE 1
Soft-LOS-NLOS-Range Field Descriptions

Soft-LOS-NLOS-Range field descriptions
soft-LOS-NLOS-Range-Id
This field defines an ID to the soft LOS/NLOS state interval that
can be used in the CSI report.
soft-LOS-NLOS-Range-Low Bound
This field defines the lower bound of the soft LOS/NLOS state interval.
The soft LOS/NLOS state is in the range between 0 and 1 describing
the probability of the link being LOS. In one embodiment, the probability
has a resolution of 0.1 and is mapped to an integer in the range of 0 to 10.
soft-LOS-NLOS-Range-UpBound
This field defines the upper bound of the soft LOS/NLOS state interval.
The soft LOS/NLOS state is in the range between 0 and 1 describing the
probability of the link being LOS. The value of soft-LOS-NLOS-Range-
UpBound shall be higher than the value of soft-LOS-NLOS-Range-
LowBound. In one embodiment, the probability has a resolution
of 0.1 and is mapped to an integer in the range of 0 to 10.

CR-Range defines a CR interval that a specific encoder model and a specific encoder output configuration applies. The field cr-Range-Id assigns an ID to each CR interval that can be used in the CSI report. The CR-Range IE looks as follows:

-- ASN1START
-- TAG-CR-RANGE-START

| | |
|---|---|
| CR-Range ::= | SEQUENCE { |
| cr-Range-Id | INTEGER (0..maxNrofCR-Range - 1), |
| cr-Range-LowBound | INTEGER (0..127), |
| cr-Range-UpBound | INTEGER (0..127) |

}
-- TAG-CR-RANGE-STOP
-- ASN1STOP

Table 2 below shows the CR-Range field descriptions:

TABLE 2
CR-Range Field Descriptions

CR-Range field descriptions
cr-Range-Id
This field defines an ID to the CR interval that can be used in the CSI
report.
cr-Range-Low Bound
This field defines the lower bound of the CR interval expressed in dB.
In one embodiment, the CR has a resolution of 1 dB and is mapped to
an integer in the range of 0 to 127. The actual value is equal to IE value,
except for the IE value 127, in which case the actual value is infinity.
cr-Range-UpBound
This field defines the upper bound of the CR interval expressed in dB. The
value of cr-Range-UpBound shall be higher than the value of cr-Range-
LowBound. In one embodiment, CR has a resolution of 1 dB and is
mapped to an integer in the range of 0 to 127. The actual value is equal
to IE value, except for the IE value 127, in which case the actual value
is infinity.

encModId specifies the ID of an encoder model that should be applied corresponding to the assistance data regarding the propagation condition. Encoder model is defined in another IE, and the encoder ID should be consistent between these two IEs. The EncModID IE is as follows:

| -- ASN1START | |
|---|---|
| -- TAG-ENCMODID-START | |
| EncModId ::= | INTEGER (0..maxNrofEncMod - 1) |

-- TAG-ENCMODID-STOP
-- ASN1STOP

enc OuputConfig specifies the encoder output configuration that should be applied corresponding to the assistance data regarding the propagation condition. Here encoder output configuration is a combination of number of encoder outputs and quantization bit-width, which determines the feedback overhead. The encOuputConfig IE is as follows:

| -- ASN1START | |
|---|---|
| -- TAG-ENCOUTPUTCONFIG-START | |
| EncOutputConfig ::= | SEQUENCE { |
| encOutputConfigId | INTEGER (0..maxNrofEncOutputConfig - 1), |
| outputWidth | ENUMERATED {w16, w32, w64, w128}, |
| quantBitWidth | ENUMERATED {q2, q4, q6, q8} |

}
-- TAG-ENCOUTPUTCONFIG-STOP
-- ASN1STOP

Table 3 below shows the EncOutputConfig field descriptions:

TABLE 3
Enc OutputConfig Field Descriptions

EncOutputConfig field descriptions
encOutputConfigId
This field specifies an ID of an encoder output configuration.
output Width
This field specifies the number of encoder outputs. Value w16 corresponds
to encoder output width of 16, value w32 corresponds to encoder
output width of 32 and so on.
quantBit Width
This field specifies the quantization bit-width of the encoder output.
Value q2 corresponds to bit-width of 2, value q4 corresponds to bit-width
of 4 and so on.

In one embodiment, BS configures an autoencoder configuration policy for each autoencoder-based CSI report. autoencoderConfigPolicyId is added in RRC CSI-reportConfig to indicate the selected policy ID. The CSI-ReportConfig IE (sent from BS to UE) is as follows:

-- ASN1START
-- TAG-CSI-REPORTCONFIG-START

| CSI-ReportConfig ::= | SEQUENCE { | |
|---|---|---|
| reportConfigId | CSI-ReportConfigId, | |
| carrier | ServCellIndex | OPTIONAL, -- Need S |

| | |
|---|---|
| resourcesForChannelMeasurement | CSI-ResourceConfigId, |

<unchanged omitted...>

| | |
|---|---|
| autoencoderConfigPolicyId | AutoencoderConfigPolicyId, |

```
  OPTIONAL,
      <unchanged omitted...>
}
-- TAG-CSI-REPORTCONFIG-STOP
-- ASN1STOP
```

Table 4 below shows the CSI-ReportConfig field descriptions:

TABLE 4
CSI-ReportConfig Field Descriptions

CSI-ReportConfig field descriptions
autoencoderConfigPolicyId
Indicates the autoencoder configuration policy that UE should employ.

In a CSI report, apart from CSI feedback fits, UE shall also indicate the assistance data regarding propagation condition that it utilizes while selecting the encoder model and the encoder output configuration so that the correct decoder is deployed at the BS. The assistance data regarding propagation condition is defined by either LOS/NLOS state or CR range, where the choice of which kind of assistance data to use is consistent with the autoencoder configuration policy specified in the corresponding CSI-ReportConfig. If hard LOS/NLOS state is utilized, then the assistanceData field of the CSI report is 1 bit (TRUE or FALSE). If soft LOS/NLOS state range or CR range is utilized, the assistanceData field of the CSI report is soft-LOS-NLOS-Range-Id or cr-Range-Id. The number of bits for soft-LOS-NLOS-Range-Id and cr-Range-Id depends on the maximum number of soft LOS/NLOS ranges or CR ranges. For example, if up to 8 soft LOS/NLOS ranges are supported, soft-LOS-NLOS-Range-Id requires 3 bits. If up to 16 CR ranges are supported, cr-Range-Id requires 4 bits. In one embodiment, UE maps the CSI reports to UCI bits sequence in the following order:
CSI report #1's assistanceData
CSI report #1's CSI feedback bits
CSI report #2's assistanceData
CSI report #2's CSI feedback bits
. . .
CSI report #n's assistanceData
CSI report #n's CSI feedback bits.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

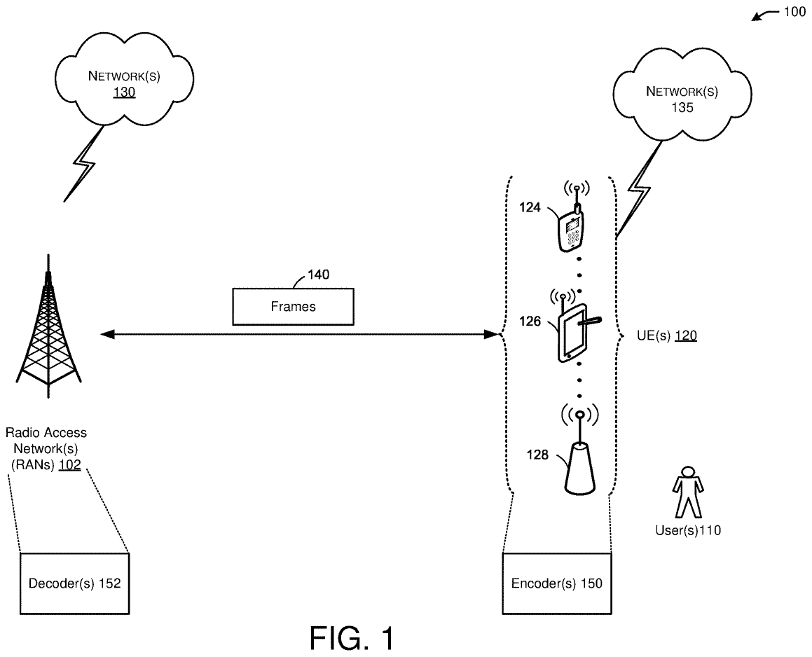

FIG. 1 is a network diagram illustrating an example network environment 100, in accordance with one or more example embodiments of the present disclosure.

Wireless network 100 may include one or more UEs 120 and one or more RANs 102 (e.g., gNBs), which may communicate in accordance with 3GPP communication standards. The UE(s) 120 may be mobile devices that are non-stationary (e.g., not having fixed locations) or may be stationary devices.

In some embodiments, the UEs 120 and the RANs 102 may include one or more computer systems similar to that of FIGS. 11-13.

One or more illustrative UE(s) 120 and/or RAN(s) 102 may be operable by one or more user(s) 110. A UE may take on multiple distinct characteristics, each of which shape its function. For example, a single addressable unit might simultaneously be a portable UE, a quality-of-service (QoS) UE, a dependent UE, and a hidden UE. The UE(s) 120 (e.g., 124, 126, or 128) and/or RAN(s) 102 may include any suitable processor-driven device including, but not limited to, a mobile device or a non-mobile, e.g., a static device. For example, UE(s) 120 may include, a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the UE(s) 120 (e.g., UEs 124, 126, 128), and UE(s) 120 may be configured to communicate with each other via one or more communications networks 130 and/or 135 wirelessly or wired. The UE(s) 120 may also communicate peer-to-peer or directly with each other with or without the RAN(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, cellular networks. In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the UE(s) 120 (e.g., UE 124, 126, 128) and RAN(s) 102 may include one or more communications antennas. The one or more communications antennas may be any suitable type of antennas corresponding to the communications protocols used by the UE(s) 120 (e.g., UEs 124, 126 and 128), and RAN(s) 102. Some non-limiting examples of suitable communications antennas include cellular antennas, 3GPP family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the UEs 120 and/or RAN(s) 102.

Any of the UE(s) 120 (e.g., UE 124, 126, 128), and RAN(s) 102 may be configured to perform directional transmission and/or directional reception in conjunction with wirelessly communicating in a wireless network. Any of the UE(s) 120 (e.g., UE 124, 126, 128), and RAN(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the UE(s) 120 (e.g., UE 124, 126, 128), and RAN(s) 102 may be configured to perform any given directional transmission towards one or more defined transmit sectors. Any of the UE(s) 120 (e.g., UE 124, 126, 128), and RAN(s) 102 may be configured to perform any given directional reception from one or more defined receive sectors.

MIMO beamforming in a wireless network may be accomplished using RF beamforming and/or digital beamforming. In some embodiments, in performing a given MIMO transmission, UE 120 and/or RAN(s) 102 may be configured to use all or a subset of its one or more communications antennas to perform MIMO beamforming.

Any of the UE 120 (e.g., UE 124, 126, 128), and RAN(s) 102 may include any suitable radio and/or transceiver for transmitting and/or receiving radio frequency (RF) signals in the bandwidth and/or channels corresponding to the communications protocols utilized by any of the UE(s) 120 and RAN(s) 102 to communicate with each other. The radio components may include hardware and/or software to modulate and/or demodulate communications signals according to pre-established transmission protocols. The radio components may further have hardware and/or software instructions to communicate via one or more 3GPP protocols and using 3GPP bandwidths. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, one or more of the UEs 120 may exchange frames 140 with the RANs 102. The frames 140 may include UL and DL frames, including CSI feedback, autoencoder configuration policy signaling, autoencoders and autoencoder configurations, CSI feedback report configurations, autoencoder-based CSI feedback capabilities, and other signaling as described herein. The UEs 120 may have one or more autoencoders 150 with which to encode the frames 140, and the RANs 102 may have one or more decoders 152 with which to decode the frames 140.

It is understood that the above descriptions are for purposes of illustration and are not meant to be limiting.

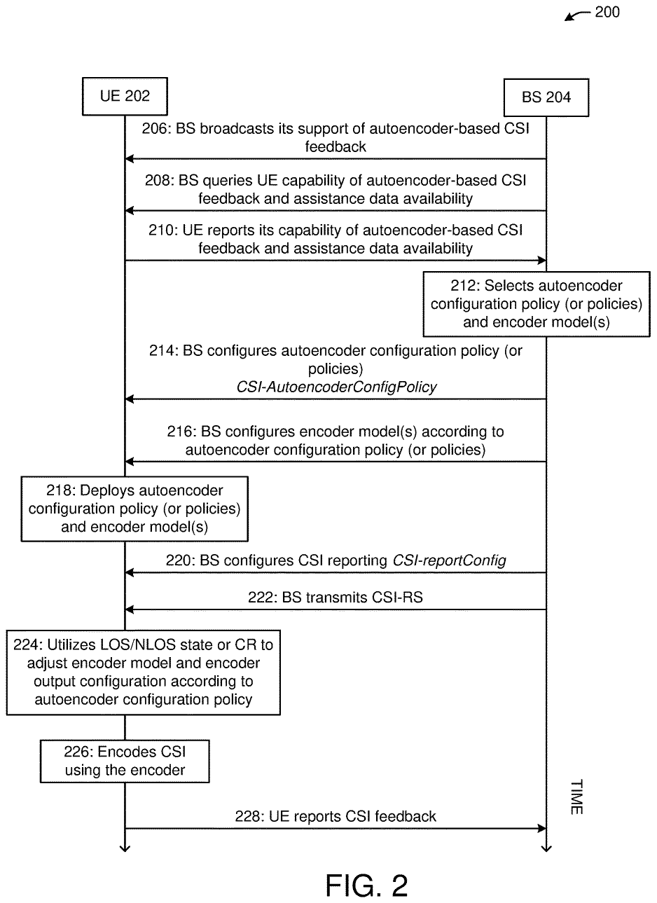

FIG. 2 is an example process 200 for propagation condition-aware encoder model and encoder output configuration adaptation, in accordance with one or more example embodiments of the present disclosure.

Referring to FIG. 2, the process 200 may include a UE 202 and a BS 204 (e.g., of the RANs 102 of FIG. 1). At step 206, the BS 204 may broadcast its support of autoencoder-based CSI feedback, and the UE 202 may receive the broadcast. At step 208, the BS may query the UE 202 for its capability to perform autoencoder-based CSI feedback and for its availability of the assistance data regarding propagation condition. At block 210, the UE 202 may report to the BS 204 its capability of autoencoder-based CSI feedback and its availability of the assistance data regarding propagation condition. At step 212, the BS 204 may select an autoencoder configuration policy (or multiple autoencoder configuration policies) and encoder model(s). At step 214, the BS may configure the autoencoder configuration policy (or policies) at the UE 202 by sending the CSI-AutoencoderConfigPolicy IE to the UE 202. At step 216, the BS 204 may configure the encoder model(s) at the UE 202 based on the autoencoder configuration policy (or policies). At step 218, the UE 202 may deploy the autoencoder configuration policy (or policies) and encoder model(s) as configured by the BS 204. At step 220, the BS 204 may configure CSI report at the UE 202 by sending the CSI-reportConfig IE to the UE 202. At step 222, the BS 204 may transmit CSI-RS to the UE 202. At step 224, the UE 202 may utilize the assistance data regarding propagation condition such as LOS/NLOS state or CR to adjust the encoder model and the encoder output configuration based on the autoencoder configuration policy. At step 226, the UE 202 may encode the CSI feedback using the encoder (e.g., the encoder 150 of FIG. 1). At step 228, the UE 202 may report the CSI feedback and the assistance data regarding propagation condition to the BS 204 by signaling the assistance data regarding propagation condition (e.g., using a bit for the LOS/NLOS state or a few bits for CR range) so that the BS 204 may identify and recover the information from the compressed data.

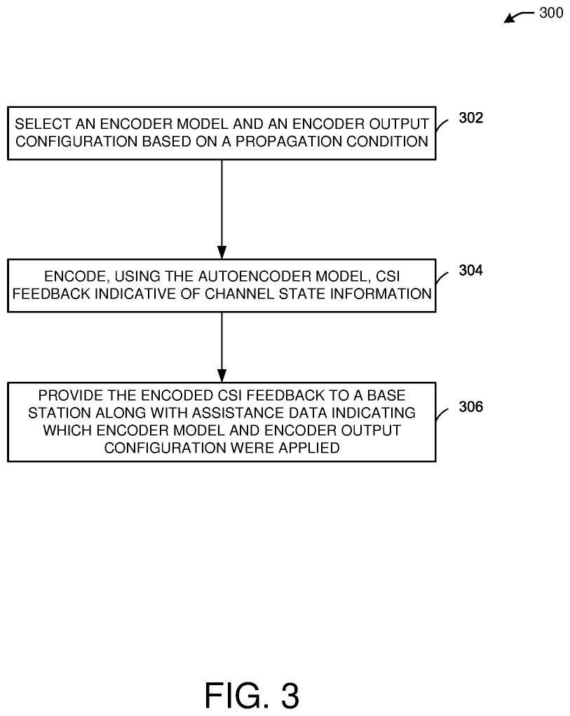

FIG. 3 illustrates a flow diagram of illustrative process 300 for adjusting the encoder model and the encoder output configuration, in accordance with one or more example embodiments of the present disclosure.

At block 302, a UE device (e.g., the UE device 202 of FIG. 2) may select an encoder model and an encoder output configuration based on a propagation condition. A base station (e.g., the BS 204 of FIG. 2) may signal an autoencoder configuration policy to the UE device to define which encoder model and which encoder output configuration to apply to a CSI feedback report from multiple encoder models and multiple encoder output configurations. The policy may define which propagation condition may correspond to which encoder model and encoder output configuration to apply so that the UE device may adjust its encoder based on propagation condition.

At block 304, the UE device may encode, using the encoder model and the encoder output configuration, CSI feedback indicative of the channel state information.

At block 306, the UE device may provide, the encoded CSI feedback to a base station. The UE device may signal to the base station (e.g., using assistance data) which encoder model and encoder output configuration were used for the CSI feedback so that the base station may apply the proper decoder to decode the CSI feedback. The signaling may include assistance data regarding propagation condition such as a LOS/NLOS state or a CR range.

These embodiments are not meant to be limiting.

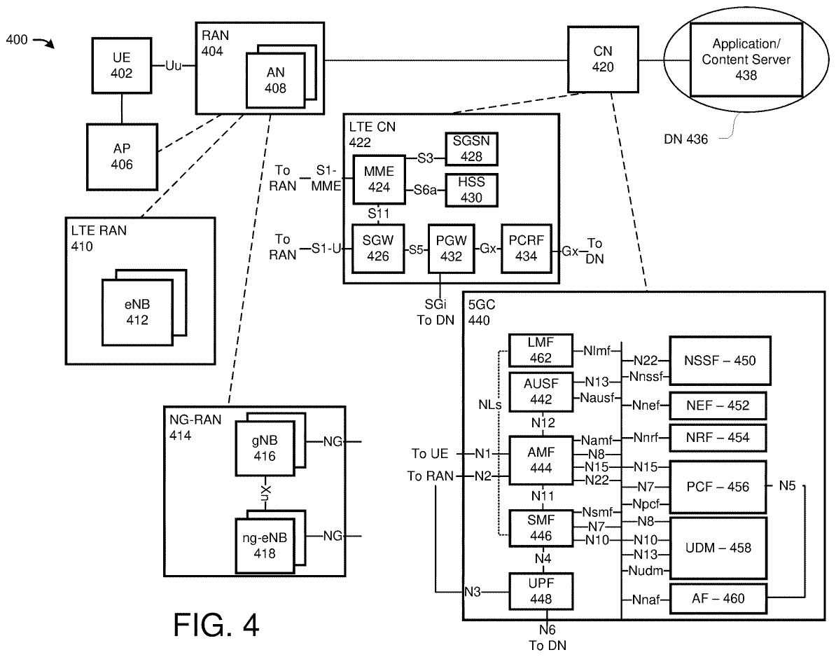

FIG. 4 illustrates a network 400 in accordance with various embodiments. The network 400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 400 may include a UE 402, which may include any mobile or non-mobile computing device designed to communicate with a RAN 404 via an over-the-air connection. The UE 402 may be communicatively coupled with the RAN 404 by a Uu interface. The UE 402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 402 may additionally communicate with an AP 406 via an over-the-air connection. The AP 406 may manage a WLAN connection, which may serve to offload some/all network traffic from the RAN 404. The connection between the UE 402 and the AP 406 may be consistent with any IEEE 802.11 protocol, wherein the AP 406 could be a wireless fidelity (Wi-Fi®) router. In some embodiments, the UE 402, RAN 404, and AP 406 may utilize cellular-WLAN aggregation (for example, LWA/LWIP). Cellular-WLAN aggregation may involve the UE 402 being configured by the RAN 404 to utilize both cellular radio resources and WLAN resources.

The RAN 404 may include one or more access nodes, for example, AN 408. AN 408 may terminate air-interface protocols for the UE 402 by providing access stratum protocols including RRC, PDCP, RLC, MAC, and L1 protocols. In this manner, the AN 408 may enable data/voice connectivity between CN 420 and the UE 402. In some embodiments, the AN 408 may be implemented in a discrete device or as one or more software entities running on server computers as part of, for example, a virtual network, which may be referred to as a CRAN or virtual baseband unit pool. The AN 408 be referred to as a BS, gNB, RAN node, eNB, ng-eNB, NodeB, RSU, TRxP, TRP, etc. The AN 408 may be a macrocell base station or a low power base station for providing femtocells, picocells or other like cells having smaller coverage areas, smaller user capacity, or higher bandwidth compared to macrocells.

In embodiments in which the RAN 404 includes a plurality of ANs, they may be coupled with one another via an X2 interface (if the RAN 404 is an LTE RAN) or an Xn interface (if the RAN 404 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 404 may each manage one or more cells, cell groups, component carriers, etc. to provide the UE 402 with an air interface for network access. The UE 402 may be simultaneously connected with a plurality of cells provided by the same or different ANs of the RAN 404. For example, the UE 402 and RAN 404 may use carrier aggregation to allow the UE 402 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 402 or AN 408 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 404 may be an LTE RAN 410 with eNBs, for example, eNB 412. The LTE RAN 410 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 404 may be an NG-RAN 414 with gNBs, for example, gNB 416, or ng-eNBs, for example, ng-eNB 418. The gNB 416 may connect with 5G-enabled UEs using a 5G NR interface. The gNB 416 may connect with a 5G core through an NG interface, which may include an N2 interface or an N3 interface. The ng-eNB 418 may also connect with the 5G core through an NG interface, but may connect with a UE via an LTE air interface. The gNB 416 and the ng-eNB 418 may connect with each other over an Xn interface.

In some embodiments, the NG interface may be split into two parts, an NG user plane (NG-U) interface, which carries traffic data between the nodes of the NG-RAN 414 and a UPF 448 (e.g., N3 interface), and an NG control plane (NG-C) interface, which is a signaling interface between the nodes of the NG-RAN 414 and an AMF 444 (e.g., N2 interface).

The NG-RAN 414 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 402 can be configured with multiple BWPs where each BWP configuration has a different SCS. When a BWP change is indicated to the UE 402, the SCS of the transmission is changed as well. Another use case example of BWP is related to power saving. In particular, multiple BWPs can be configured for the UE 402 with different amount of frequency resources (for example, PRBs) to support data transmission under different traffic loading scenarios. A BWP containing a smaller number of PRBs can be used for data transmission with small traffic load while allowing power saving at the UE 402 and in some cases at the gNB 416. A BWP containing a larger number of PRBs can be used for scenarios with higher traffic load.

The RAN 404 is communicatively coupled to CN 420 that includes network elements to provide various functions to support data and telecommunications services to customers/subscribers (for example, users of UE 402). The components of the CN 420 may be implemented in one physical node or separate physical nodes. In some embodiments, NFV may be utilized to virtualize any or all of the functions provided by the network elements of the CN 420 onto physical compute/storage resources in servers, switches, etc. A logical instantiation of the CN 420 may be referred to as a network slice, and a logical instantiation of a portion of the CN 420 may be referred to as a network sub-slice.

In some embodiments, the CN 420 may be an LTE CN 422, which may also be referred to as an EPC. The LTE CN 422 may include MME 424, SGW 426, SGSN 428, HSS 430, PGW 432, and PCRF 434 coupled with one another over interfaces (or “reference points”) as shown. Functions of the elements of the LTE CN 422 may be briefly introduced as follows.

The MME 424 may implement mobility management functions to track a current location of the UE 402 to facilitate paging, bearer activation/deactivation, handovers, gateway selection, authentication, etc.

The SGW 426 may terminate an S1 interface toward the RAN and route data packets between the RAN and the LTE CN 422. The SGW 426 may be a local mobility anchor point for inter-RAN node handovers and also may provide an anchor for inter-3GPP mobility. Other responsibilities may include lawful intercept, charging, and some policy enforcement. The SGSN 428 may track a location of the UE 402 and perform security functions and access control. In addition, the SGSN 428 may perform inter-EPC node signaling for mobility between different RAT networks; PDN and S-GW selection as specified by MME 424; MME selection for handovers; etc. The S3 reference point between the MME 424 and the SGSN 428 may enable user and bearer information exchange for inter-3GPP access network mobility in idle/active states.

The HSS 430 may include a database for network users, including subscription-related information to support the network entities' handling of communication sessions. The HSS 430 can provide support for routing/roaming, authentication, authorization, naming/addressing resolution, location dependencies, etc. An S6a reference point between the HSS 430 and the MME 424 may enable transfer of subscription and authentication data for authenticating/authorizing user access to the LTE CN 420.

The PGW 432 may terminate an SGi interface toward a data network (DN) 436 that may include an application/content server 438. The PGW 432 may route data packets between the LTE CN 422 and the data network 436. The PGW 432 may be coupled with the SGW 426 by an S5 reference point to facilitate user plane tunneling and tunnel management. The PGW 432 may further include a node for policy enforcement and charging data collection (for example, PCEF). Additionally, the SGi reference point between the PGW 432 and the data network 436 may be an operator external public, a private PDN, or an intra-operator packet data network, for example, for provision of IMS services. The PGW 432 may be coupled with a PCRF 434 via a Gx reference point.

The PCRF 434 is the policy and charging control element of the LTE CN 422. The PCRF 434 may be communicatively coupled to the app/content server 438 to determine appropriate QoS and charging parameters for service flows. The PCRF 1132 may provision associated rules into a PCEF (via Gx reference point) with appropriate TFT and QCI.

In some embodiments, the CN 420 may be a 5GC 440. The 5GC 440 may include an AUSF 442, AMF 444, SMF 446, UPF 448, NSSF 450, NEF 452, NRF 454, PCF 456, UDM 458, and AF 460 coupled with one another over interfaces (or “reference points”) as shown. Functions of the elements of the 5GC 440 may be briefly introduced as follows.

The AUSF 442 may store data for authentication of UE 402 and handle authentication-related functionality. The AUSF 442 may facilitate a common authentication framework for various access types. In addition to communicating with other elements of the 5GC 440 over reference points as shown, the AUSF 442 may exhibit an Nausf service-based interface.

The AMF 444 may allow other functions of the 5GC 440 to communicate with the UE 402 and the RAN 404 and to subscribe to notifications about mobility events with respect to the UE 402. The AMF 444 may be responsible for registration management (for example, for registering UE 402), connection management, reachability management, mobility management, lawful interception of AMF-related events, and access authentication and authorization. The AMF 444 may provide transport for SM messages between the UE 402 and the SMF 446, and act as a transparent proxy for routing SM messages. AMF 444 may also provide transport for SMS messages between UE 402 and an SMSF. AMF 444 may interact with the AUSF 442 and the UE 402 to perform various security anchor and context management functions. Furthermore, AMF 444 may be a termination point of a RAN CP interface, which may include or be an N2 reference point between the RAN 404 and the AMF 444; and the AMF 444 may be a termination point of NAS (N1) signaling, and perform NAS ciphering and integrity protection. AMF 444 may also support NAS signaling with the UE 402 over an N3 IWF interface.

The SMF 446 may be responsible for SM (for example, session establishment, tunnel management between UPF 448 and AN 408); UE IP address allocation and management (including optional authorization); selection and control of UP function; configuring traffic steering at UPF 448 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 444 over N2 to AN 408; and determining SSC mode of a session. SM may refer to management of a PDU session, and a PDU session or “session” may refer to a PDU connectivity service that provides or enables the exchange of PDUs between the UE 402 and the data network 436.

The UPF 448 may act as an anchor point for intra-RAT and inter-RAT mobility, an external PDU session point of interconnect to data network 436, and a branching point to support multi-homed PDU session. The UPF 448 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 448 may include an uplink classifier to support routing traffic flows to a data network.

The NSSF 450 may select a set of network slice instances serving the UE 402. The NSSF 450 may also determine allowed NSSAI and the mapping to the subscribed S-NSSAIs, if needed. The NSSF 450 may also determine the AMF set to be used to serve the UE 402, or a list of candidate AMFs based on a suitable configuration and possibly by querying the NRF 454. The selection of a set of network slice instances for the UE 402 may be triggered by the AMF 444 with which the UE 402 is registered by interacting with the NSSF 450, which may lead to a change of AMF. The NSSF 450 may interact with the AMF 444 via an N22 reference point; and may communicate with another NSSF in a visited network via an N31 reference point (not shown). Additionally, the NSSF 450 may exhibit an Nnssf service-based interface.

The NEF 452 may securely expose services and capabilities provided by 3GPP network functions for third party, internal exposure/re-exposure, AFs (e.g., AF 460), edge computing or fog computing systems, etc. In such embodiments, the NEF 452 may authenticate, authorize, or throttle the AFs. NEF 452 may also translate information exchanged with the AF 1160 and information exchanged with internal network functions. For example, the NEF 452 may translate between an AF-Service-Identifier and an internal 5GC information. NEF 452 may also receive information from other NFs based on exposed capabilities of other NFs. This information may be stored at the NEF 452 as structured data, or at a data storage NF using standardized interfaces. The stored information can then be re-exposed by the NEF 452 to other NFs and AFs, or used for other purposes such as analytics. Additionally, the NEF 452 may exhibit an Nnef service-based interface.

The NRF 454 may support service discovery functions, receive NF discovery requests from NF instances, and provide the information of the discovered NF instances to the NF instances. NRF 454 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 454 may exhibit the Nnrf service-based interface.

The PCF 456 may provide policy rules to control plane functions to enforce them, and may also support unified policy framework to govern network behavior. The PCF 456 may also implement a front end to access subscription information relevant for policy decisions in a UDR of the UDM 458. In addition to communicating with functions over reference points as shown, the PCF 456 exhibit an Npcf service-based interface.

The UDM 458 may handle subscription-related information to support the network entities' handling of communication sessions, and may store subscription data of UE 402. For example, subscription data may be communicated via an N8 reference point between the UDM 458 and the AMF 444. The UDM 458 may include two parts, an application front end and a UDR. The UDR may store subscription data and policy data for the UDM 458 and the PCF 456, and/or structured data for exposure and application data (including PFDs for application detection, application request information for multiple UEs 402) for the NEF 452. The Nudr service-based interface may be exhibited by the UDR to allow the UDM 458, PCF 456, and NEF 452 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 458 may exhibit the Nudm service-based interface.

The AF 460 may provide application influence on traffic routing, provide access to NEF, and interact with the policy framework for policy control.

In some embodiments, the 5GC 440 may enable edge computing by selecting operator/3^{rd} party services to be geographically close to a point that the UE 402 is attached to the network. This may reduce latency and load on the network. To provide edge-computing implementations, the 5GC 440 may select a UPF 448 close to the UE 402 and execute traffic steering from the UPF 448 to data network 436 via the N6 interface. This may be based on the UE subscription data, UE location, and information provided by the AF 460. In this way, the AF 460 may influence UPF (re) selection and traffic routing. Based on operator deployment, when AF 460 is considered to be a trusted entity, the network operator may permit AF 460 to interact directly with relevant NFs. Additionally, the AF 460 may exhibit an Naf service-based interface.

The data network 436 may represent various network operator services, Internet access, or third party services that may be provided by one or more servers including, for example, application/content server 438.

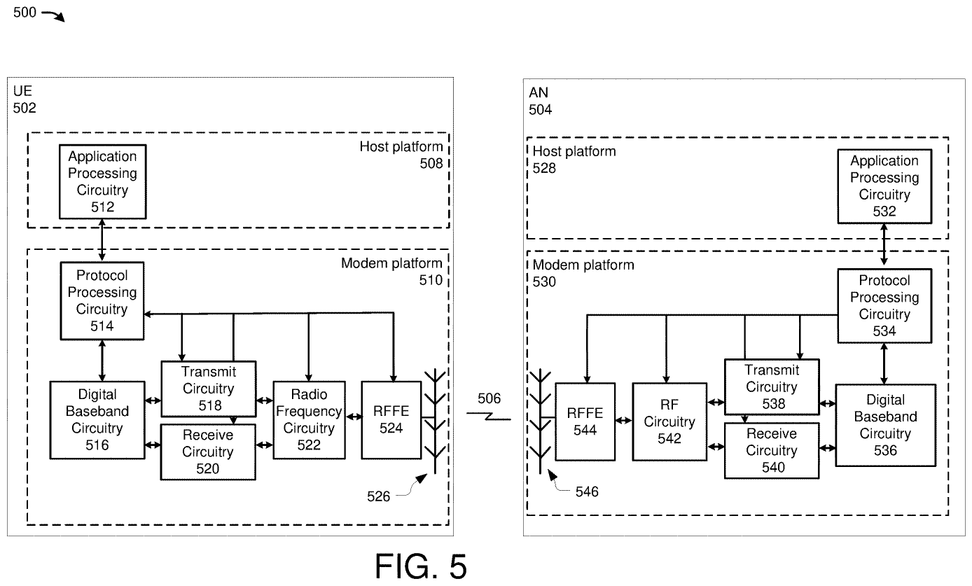

FIG. 5 schematically illustrates a wireless network 500 in accordance with various embodiments. The wireless network 500 may include a UE 502 in wireless communication with an AN 504. The UE 502 and AN 504 may be similar to, and substantially interchangeable with, like-named components described elsewhere herein.

The UE 502 may be communicatively coupled with the AN 504 via connection 506. The connection 506 is illustrated as an air interface to enable communicative coupling, and can be consistent with cellular communications protocols such as an LTE protocol or a 5G NR protocol operating at mmWave or sub-6 GHz frequencies.

The UE 502 may include a host platform 508 coupled with a modem platform 510. The host platform 508 may include application processing circuitry 512, which may be coupled with protocol processing circuitry 514 of the modem platform 510. The application processing circuitry 512 may run various applications for the UE 502 that source/sink application data. The application processing circuitry 512 may further implement one or more layer operations to transmit/receive application data to/from a data network. These layer operations may include transport (for example UDP) and Internet (for example, IP) operations

The protocol processing circuitry 514 may implement one or more of layer operations to facilitate transmission or reception of data over the connection 506. The layer operations implemented by the protocol processing circuitry 514 may include, for example, MAC, RLC, PDCP, RRC and NAS operations.

The modem platform 510 may further include digital baseband circuitry 516 that may implement one or more layer operations that are “below” layer operations performed by the protocol processing circuitry 514 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 510 may further include transmit circuitry 518, receive circuitry 520, RF circuitry 522, and RF front end (RFFE) 524, which may include or connect to one or more antenna panels 526. Briefly, the transmit circuitry 518 may include a digital-to-analog converter, mixer, intermediate frequency (IF) components, etc.; the receive circuitry 520 may include an analog-to-digital converter, mixer, IF components, etc.; the RF circuitry 522 may include a low-noise amplifier, a power amplifier, power tracking components, etc.; RFFE 524 may include filters (for example, surface/bulk acoustic wave filters), switches, antenna tuners, beamforming components (for example, phase-array antenna components), etc. The selection and arrangement of the components of the transmit circuitry 518, receive circuitry 520, RF circuitry 522, RFFE 524, and antenna panels 526 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 514 may include one or more instances of control circuitry (not shown) to provide control functions for the transmit/receive components.

A UE reception may be established by and via the antenna panels 526, RFFE 524, RF circuitry 522, receive circuitry 520, digital baseband circuitry 516, and protocol processing circuitry 514. In some embodiments, the antenna panels 526 may receive a transmission from the AN 504 by receive-beamforming signals received by a plurality of antennas/antenna elements of the one or more antenna panels 526.

A UE transmission may be established by and via the protocol processing circuitry 514, digital baseband circuitry 516, transmit circuitry 518, RF circuitry 522, RFFE 524, and antenna panels 526. In some embodiments, the transmit components of the UE 504 may apply a spatial filter to the data to be transmitted to form a transmit beam emitted by the antenna elements of the antenna panels 526.

Similar to the UE 502, the AN 504 may include a host platform 528 coupled with a modem platform 530. The host platform 528 may include application processing circuitry 532 coupled with protocol processing circuitry 534 of the modem platform 530. The modem platform may further include digital baseband circuitry 536, transmit circuitry 538, receive circuitry 540, RF circuitry 542, RFFE circuitry 544, and antenna panels 546. The components of the AN 504 may be similar to and substantially interchangeable with like-named components of the UE 502. In addition to performing data transmission/reception as described above, the components of the AN 508 may perform various logical functions that include, for example, RNC functions such as radio bearer management, uplink and downlink dynamic radio resource management, and data packet scheduling.

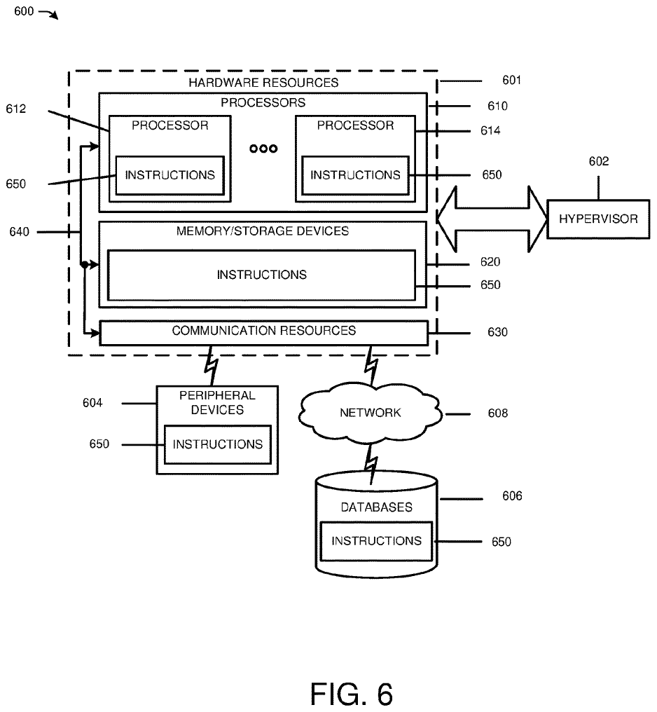

FIG. 6 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 6 shows a diagrammatic representation of hardware resources 600 including one or more processors (or processor cores) 610, one or more memory/storage devices 620, and one or more communication resources 630, each of which may be communicatively coupled via a bus 640 or other interface circuitry. For embodiments where node virtualization (e.g., NFV) is utilized, a hypervisor 602 may be executed to provide an execution environment for one or more network slices/sub-slices to utilize the hardware resources 600.

The processors 610 may include, for example, a processor 612 and a processor 614. The processors 610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 620 may include main memory, disk storage, or any suitable combination thereof. The memory/storage devices 620 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 630 may include interconnection or network interface controllers, components, or other suitable devices to communicate with one or more peripheral devices 604 or one or more databases 606 or other network elements via a network 608. For example, the communication resources 630 may include wired communication components (e.g., for coupling via USB, Ethernet, etc.), cellular communication components, NFC components, Bluetooth® (or Bluetooth® Low Energy) components, Wi-Fi® components, and other communication components.

Instructions 650 may comprise software, a program, an application, an applet, an app, or other executable code for causing at least any of the processors 610 to perform any one or more of the methodologies discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 600 from any combination of the peripheral devices 604 or the databases 606. Accordingly, the memory of processors 610, the memory/storage devices 620, the peripheral devices 604, and the databases 606 are examples of computer-readable and machine-readable media.

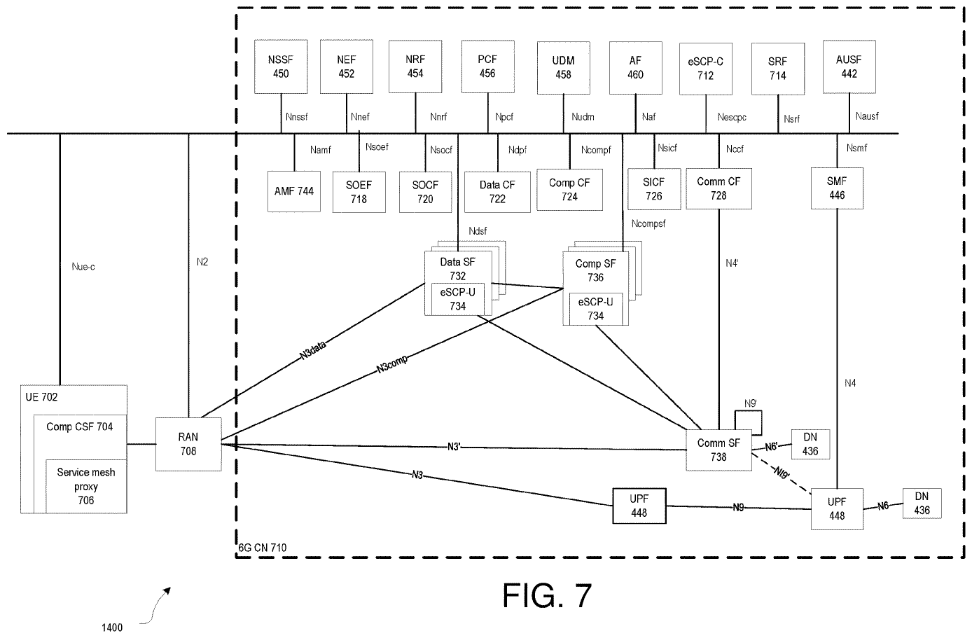

FIG. 7 illustrates a network, in accordance with one or more example embodiments of the present disclosure.

The network 700 may operate in a matter consistent with 3GPP technical specifications or technical reports for 6G systems. In some examples, the network 700 may operate concurrently with network 400. For example, in some examples, the network 700 may share one or more frequency or bandwidth resources with network 400. As one specific example, a UE (e.g., UE 702) may be configured to operate in both network 700 and network 400. Such configuration may be based on a UE including circuitry configured for communication with frequency and bandwidth resources of both networks 400 and 700. In general, several elements of network 700 may share one or more characteristics with elements of network 400. For the sake of brevity and clarity, such elements may not be repeated in the description of network 700.

The network 700 may include a UE 702, which may include any mobile or non-mobile computing device designed to communicate with a RAN 708 via an over-the-air connection. The UE 702 may be similar to, for example, UE 402. The UE 702 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 7, in some examples the network 700 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 7, the UE 702 may be communicatively coupled with an AP such as AP 406 as described with respect to FIG. 4. Additionally, although not specifically shown in FIG. 7, in some examples the RAN 708 may include one or more ANs such as AN 408 as described with respect to FIG. 7. The RAN 708 and/or the AN of the RAN 708 may be referred to as a base station (BS), a RAN node, or using some other term or name.

The UE 702 and the RAN 708 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 708 may allow for communication between the UE 702 and a 6G core network (CN) 710. Specifically, the RAN 708 may facilitate the transmission and reception of data between the UE 702 and the 6G CN 710. The 6G CN 710 may include various functions such as NSSF 450, NEF 452, NRF 454, PCF 456, UDM 458, AF 460, SMF 446, and AUSF 442. The 6G CN 710 may additional include UPF 448 and DN 436 as shown in FIG. 7.

Additionally, the RAN 708 may include various additional functions that are in addition to, or alternative to, functions of a legacy cellular network such as a 4G or 5G network. Two such functions may include a Compute Control Function (Comp CF) 724 and a Compute Service Function (Comp SF) 736. The Comp CF 724 and the Comp SF 736 may be parts or functions of the Computing Service Plane. Comp CF 724 may be a control plane function that provides functionalities such as management of the Comp SF 736, computing task context generation and management (e.g., create, read, modify, delete), interaction with the underlaying computing infrastructure for computing resource management, etc. Comp SF 736 may be a user plane function that serves as the gateway to interface computing service users (such as UE 702) and computing nodes behind a Comp SF instance. Some functionalities of the Comp SF 736 may include: parse computing service data received from users to compute tasks executable by computing nodes; hold service mesh ingress gateway or service API gateway; service and charging policies enforcement; performance monitoring and telemetry collection, etc. In some examples, a Comp SF 736 instance may serve as the user plane gateway for a cluster of computing nodes. A Comp CF 724 instance may control one or more Comp SF 736 instances.

Two other such functions may include a Communication Control Function (Comm CF) 728 and a Communication Service Function (Comm SF) 738, which may be parts of the Communication Service Plane. The Comm CF 728 may be the control plane function for managing the Comm SF 738, communication sessions creation/configuration/releasing, and managing communication session context. The Comm SF 738 may be a user plane function for data transport. Comm CF 728 and Comm SF 738 may be considered as upgrades of SMF 446 and UPF 448, which were described with respect to a 5G system in FIG. 4. The upgrades provided by the Comm CF 728 and the Comm SF 738 may enable service-aware transport. For legacy (e.g., 4G or 5G) data transport, SMF 446 and UPF 448 may still be used.

Two other such functions may include a Data Control Function (Data CF) 722 and Data Service Function (Data SF) 732 may be parts of the Data Service Plane. Data CF 722 may be a control plane function and provides functionalities such as Data SF 732 management, Data service creation/configuration/releasing, Data service context management, etc. Data SF 732 may be a user plane function and serve as the gateway between data service users (such as UE 702 and the various functions of the 6G CN 710) and data service endpoints behind the gateway. Specific functionalities may include: parse data service user data and forward to corresponding data service endpoints, generate charging data, report data service status.

Another such function may be the Service Orchestration and Chaining Function (SOCF) 720, which may discover, orchestrate and chain up communication/computing/data services provided by functions in the network. Upon receiving service requests from users, SOCF 720 may interact with one or more of Comp CF 724, Comm CF 728, and Data CF 722 to identify Comp SF 736, Comm SF 738, and Data SF 732 instances, configure service resources, and generate the service chain, which could contain multiple Comp SF 736, Comm SF 738, and Data SF 732 instances and their associated computing endpoints. Workload processing and data movement may then be conducted within the generated service chain. The SOCF 720 may also responsible for maintaining, updating, and releasing a created service chain.

Another such function may be the service registration function (SRF) 714, which may act as a registry for system services provided in the user plane such as services provided by service endpoints behind Comp SF 736 and Data SF 732 gateways and services provided by the UE 702. The SRF 714 may be considered a counterpart of NRF 454, which may act as the registry for network functions.

Other such functions may include an evolved service communication proxy (eSCP) and service infrastructure control function (SICF) 726, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 712 and eSCP-U 734, for control plane service communication proxy and user plane service communication proxy, respectively. The SICF 726 may control and configure eCSP instances in terms of service traffic routing policies, access rules, load balancing configurations, performance monitoring, etc.

Another such function is the AMF 744. The AMF 744 may be similar to 444, but with additional functionality. Specifically, the AMF 744 may include potential functional repartition, such as move the message forwarding functionality from the AMF 744 to the RAN 708.

Another such function is the service orchestration exposure function (SOEF) 718. The SOEF may be configured to expose service orchestration and chaining services to external users such as applications.

The UE 702 may include an additional function that is referred to as a computing client service function (comp CSF) 704. The comp CSF 704 may have both the control plane functionalities and user plane functionalities, and may interact with corresponding network side functions such as SOCF 720, Comp CF 724, Comp SF 736, Data CF 722, and/or Data SF 732 for service discovery, request/response, compute task workload exchange, etc. The Comp CSF 704 may also work with network side functions to decide on whether a computing task should be run on the UE 702, the RAN 708, and/or an element of the 6G CN 710.

The UE 702 and/or the Comp CSF 704 may include a service mesh proxy 706. The service mesh proxy 706 may act as a proxy for service-to-service communication in the user plane. Capabilities of the service mesh proxy 706 may include one or more of addressing, security, load balancing, and/or the like.

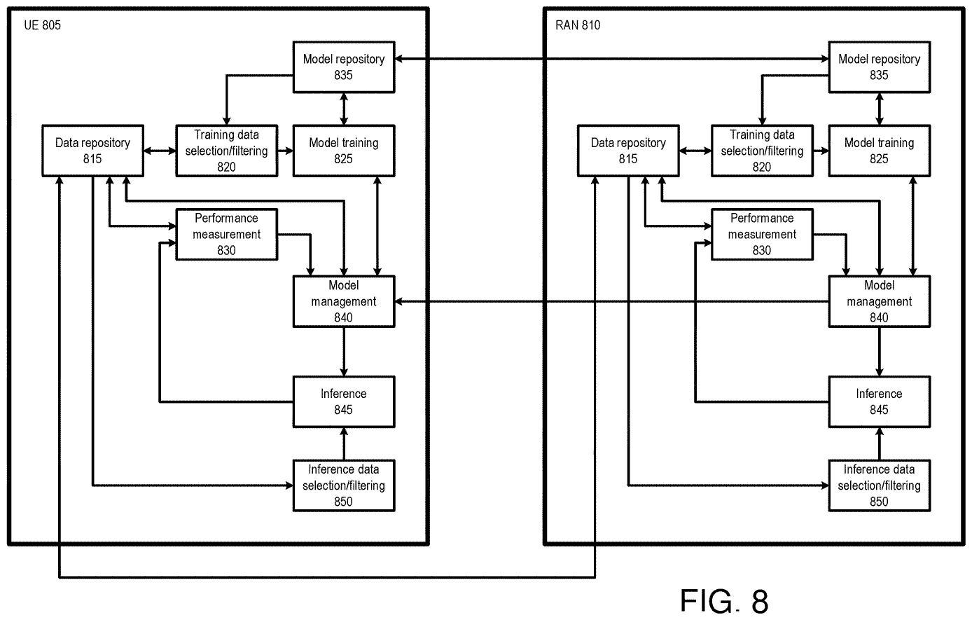

FIG. 8 illustrates a simplified block diagram of artificial (AI)-assisted communication between a user equipment and a radio access network, in accordance with one or more example embodiments of the present disclosure.

FIG. 8 depicts an example artificial (AI)-assisted communication architecture. More specifically, as described in further detail below, AI/machine learning (ML) models may be used or leveraged to facilitate over-the-air communication between UE 805 and RAN 810.

In this example, the UE 805 and the RAN 810 operate in a matter consistent with 3GPP technical specifications and/or technical reports for 6G systems. In some examples, the wireless cellular communication between the UE 805 and the RAN 810 may be part of, or operate concurrently with, networks 400, 700, and/or some other network described herein.

The UE Error! Reference source not found.05 may be similar to, and share one or more features with, UE 402, UE 702, and/or some other UE described herein. The UE 805 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 810 may be similar to, and share one or more features with, RAN 414, RAN 708, and/or some other RAN described herein.

As may be seen in FIG. 8, the AI-related elements of UE 805 may be similar to the AI-related elements of RAN 810. For the sake of discussion herein, description of the various elements will be provided from the point of view of the UE 805, however it will be understood that such discussion or description will apply to equally named/numbered elements of RAN 810, unless explicitly stated otherwise.

As previously noted, the UE 805 may include various elements or functions that are related to AI/ML. Such elements may be implemented as hardware, software, firmware, and/or some combination thereof. In examples, one or more of the elements may be implemented as part of the same hardware (e.g., chip or multi-processor chip), software (e.g., a computing program), or firmware as another element.

One such element may be a data repository 815. The data repository 815 may be responsible for data collection and storage. Specifically, the data repository 815 may collect and store RAN configuration parameters, measurement data, performance key performance indicators (KPIs), model performance metrics, etc., for model training, update, and inference. More generally, collected data is stored into the repository. Stored data can be discovered and extracted by other elements from the data repository 815. For example, as may be seen, the inference data selection/filter element 850 may retrieve data from the data repository 815. In various examples, the UE 805 may be configured to discover and request data from the data repository 815 in the RAN, and vice versa. More generally, the data repository 815 of the UE 805 may be communicatively coupled with the data repository 815 of the RAN 810 such that the respective data repositories of the UE and the RAN may share collected data with one another.

Another such element may be a training data selection/filtering functional block 820. The training data selection/filter functional block 820 may be configured to generate training, validation, and testing datasets for model training. Training data may be extracted from the data repository 815. Data may be selected/filtered based on the specific AI/ML model to be trained. Data may optionally be transformed/augmented/pre-processed (e.g., normalized) before being loaded into datasets. The training data selection/filter functional block 820 may label data in datasets for supervised learning. The produced datasets may then be fed into model training the model training functional block 825.

As noted above, another such element may be the model training functional block 825. This functional block may be responsible for training and updating (re-training) AI/ML models. The selected model may be trained using the fed-in datasets (including training, validation, testing) from the training data selection/filtering functional block. The model training functional block 825 may produce trained and tested AI/ML models which are ready for deployment. The produced trained and tested models can be stored in a model repository 835.

The model repository 835 may be responsible for AI/ML models' (both trained and un-trained) storage and exposure. Trained/updated model(s) may be stored into the model repository 835. Model and model parameters may be discovered and requested by other functional blocks (e.g., the training data selection/filter functional block 820 and/or the model training functional block 825). In some examples, the UE 805 may discover and request AI/ML models from the model repository 835 of the RAN 810. Similarly, the RAN 810 may be able to discover and/or request AI/ML models from the model repository 835 of the UE 805. In some examples, the RAN 810 may configure models and/or model parameters in the model repository 835 of the UE 805.

Another such element may be a model management functional block 840. The model management functional block 840 may be responsible for management of the AI/ML model produced by the model training functional block 825. Such management functions may include deployment of a trained model, monitoring model performance, etc. In model deployment, the model management functional block 840 may allocate and schedule hardware and/or software resources for inference, based on received trained and tested models. As used herein, “inference” refers to the process of using trained AI/ML model(s) to generate data analytics, actions, policies, etc. based on input inference data. In performance monitoring, based on wireless performance KPIs and model performance metrics, the model management functional block 840 may decide to terminate the running model, start model re-training, select another model, etc. In examples, the model management functional block 840 of the RAN 810 may be able to configure model management policies in the UE 805 as shown.

Another such element may be an inference data selection/filtering functional block 850. The inference data selection/filter functional block 850 may be responsible for generating datasets for model inference at the inference functional block 845, as described below. Specifically, inference data may be extracted from the data repository 815. The inference data selection/filter functional block 850 may select and/or filter the data based on the deployed AI/ML model. Data may be transformed/augmented/pre-processed following the same transformation/augmentation/pre-processing as those in training data selection/filtering as described with respect to functional block 820. The produced inference dataset may be fed into the inference functional block 845.

Another such element may be the inference functional block 845. The inference functional block 845 may be responsible for executing inference as described above. Specifically, the inference functional block 845 may consume the inference dataset provided by the inference data selection/filtering functional block 850, and generate one or more outcomes. Such outcomes may be or include data analytics, actions, policies, etc. The outcome(s) may be provided to the performance measurement functional block 830.

The performance measurement functional block 830 may be configured to measure model performance metrics (e.g., accuracy, model bias, run-time latency, etc.) of deployed and executing models based on the inference outcome(s) for monitoring purpose. Model performance data may be stored in the data repository 815.

The following examples pertain to further embodiments.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Example 1 may include a user equipment (UE) device for adjusting an encoder model and an encoder output configuration, the UE device comprising processing circuitry coupled to storage for storing information associated with the encoder model and encoder output configuration, the processing circuitry configured to: select an encoder model based on a propagation condition; select an encoder output configuration based on the propagation condition; encode, using the encoder model and the encoder output configuration, channel state information (CSI) feedback indicative of channel state information; and provide, the encoded CSI feedback and a signal that indicates the propagation condition to a base station.

Example 2 may include the UE device of example 1 and/or any other example herein, wherein the propagation condition is based on a contrast ratio of a channel matrix in an angular-delay domain.

Example 3 may include the UE device of example 1 and/or any other example herein, wherein to select the encoder model and the encoder output configuration is further based on a CSI-AutoencoderConfigPolicy information element received from the base station, the CSI-AutoencoderConfigPolicy information element comprising an autoencoder configuration policy identifier and a list of autoencoder configurations, wherein each autoencoder configuration is a combination of assistance data that indicates a respective propagation condition, and an encoder model and an encoder output configuration that should be applied under the propagation condition.

Example 4 may include the UE device of example 3 and/or any other example herein, wherein the list of autoencoder configurations is further defined based on an autoencoderConfigList information element received from the base station, the autoencoderConfigList information element defining a list of autoencoder configurations to apply based on a policy indicated by the CSI-AutoencoderConfigPolicy information element.

Example 5 may include the UE device of example 4 and/or any other example herein, wherein each autoencoder configuration within the list of autoencoder configurations is further based on an autoencoderConfig information element received from the base station, the autoencoderConfig information element comprising an assistance data field that reflects propagation condition, an encoder model identifier field, and an encoder output configuration field, and wherein the assistance data field signals that the UE device is to apply the encoder model as specified by the encoder model identifier field and the encoder output configuration as specified by the encoder model identifier field under the propagation condition defined by the assistance data field.

Example 6 may include the UE device of example 5 and/or any other example herein, wherein the assistance data field signals that the UE device is to apply a specific encoder model and a specific encoder output configuration based on a line-of-sight (LOS)/non-LOS (NLOS) state, and wherein the LOS/NLOS state indicates that whether a link from the UE device to the base station is LOS or non-LOS.

Example 7 may include the UE device of example 6 and/or any other example herein, wherein the LOS/NLOS state is further defined by LOS-NLOS-State information element received from the base station, the LOS-NLOS-State information element comprising either a hard LOS/NLOS state or an interval of a soft LOS/NLOS state indicating a probability of the link between the UE device and the base station being LOS.

Example 8 may include the UE device of example 7 and/or any other example herein, wherein the interval of a soft LOS/NLOS state is further defined by a Soft-LOS-NLOS-Range information element comprising a Soft-LOS-NLOS-Range identifier, a lower bound of the soft LOS/NLOS state, and an upper bound of the soft LOS/NLOS state.

Example 9 may include the UE device of example 5 and/or any other example herein, wherein the assistance data field signals that the UE device is to apply a specific encoder model and a specific encoder output configuration is based on a contrast ratio (CR) range, and wherein the processing circuitry is further configured to modify encoder model and encoder output configuration based on the CR range.

Example 10 may include the UE device of example 9 and/or any other example herein, wherein a CR-Range information element received from the base station defines a CR interval of the CR and comprises a CR range identifier, a lower bound of the CR range, and an upper bound of the CR range.

Example 11 may include the UE device of example 1 and/or any other example herein, wherein the processing circuitry is further configured to: encode, using the encoder model and the encoder output configuration, second CSI feedback indicative of a second channel state information; and provide the second encoded CSI feedback and second assistance data indicating the propagation condition to the base station.

Example 12 may include the UE device of claim 1 and/or any other example herein, wherein to provide a CSI report that includes the encoded CSI feedback and the signal that indicates the propagation condition to the base station using a first autoencoder configuration policy for the encoded CSI feedback and the signal that indicates the propagation condition, wherein the processing circuitry is further configured to provide second CSI report that includes second encoded CSI feedback and second assistance data indicating the propagation condition to the base station using a second autoencoder configuration policy, and wherein the UE device receives the first autoencoder configuration policy and the second autoencoder configuration policy from the base station.

Example 13 may include the UE device of example 12 and/or any other example herein, wherein a first CSI-ReportConfig information element of the CSI report configuration received by the UE device from the base station signals a first autoencoderConfigPolicyId to identify the first autoencoder configuration policy, and wherein a second CSI-ReportConfig information element of the second CSI report configuration signals a second autoencoderConfigPolicyld to identify the second autoencoder configuration policy.

Example 14 may include the UE device of example 1 and/or any other example herein, wherein to provide the encoded CSI feedback to the base station comprises to signal assistance data regarding propagation condition to the base station, the assistance data indicative of the encoder model and encoder output configuration selected by the UE device.

Example 15 may include the UE device of example 14 and/or any other example herein, wherein the assistance data indicating the propagation condition indicates a LOS or NLOS state.

Example 16 may include the UE device of example 14 and/or any other example herein, wherein the assistance data regarding propagation condition is indicated by a range signaled by a LOS or NLOS range identifier.

Example 17 may include the UE device of example 14 and/or any other example herein, where in the assistance data indicating the propagation condition indicates a CR range signaled by a CR range identifier.

Example 18 may include a computer-readable storage medium comprising instructions to cause processing circuitry of a base station for adjusting an encoder model and an encoder output configuration, upon execution of the instructions by the processing circuitry, to: provide, to a user equipment (UE) device, a CSI autoencoder configuration policy defining which encoder model from among multiple encoder models to select and which encoder output configuration from among multiple encoder output configurations to select under a specific propagation condition experienced by the UE device; provide, to the UE device, a CSI report configuration to apply to a CSI report; provide, to the UE device, in the CSI report configuration, an autoencoder configuration policy to apply to a CSI feedback report; detect an encoded CSI feedback report and an assistance data indicating a propagation condition, received from the UE device, indicating an encoder model and an encoder output configuration used in a CSI feedback report from the UE device; and decode, based on the autoencoder configuration policy, a CSI feedback report from the encoded CSI feedback report, wherein the CSI feedback report comprises both encoded CSI feedback and assistance data indicating the propagation condition, received from the UE device, wherein the CSI feedback report is based on the CSI report configuration.

Example 19 may include the computer-readable storage medium of example 18 and/or any other example herein, wherein the assistance data indicating the propagation condition comprises a line-of-sight (LOS)/non-LOS (NLOS) state identifier.

Example 20 may include the computer-readable storage medium of example 18 and/or any other example herein, wherein the assistance data indicating the propagation condition comprises a contrast ratio identifier.

Example 21 may include a method for adjusting an encoder model and an encoder output configuration, the method comprising: selecting, by processing circuitry of a user equipment (UE) device, an encoder model based on a propagation condition; selecting, by the processing circuitry, an encoder output configuration based on the propagation condition;

encoding, by the processing circuitry, using the encoder model and encoder output configuration, CSI feedback indicative of channel state information; and providing, by the processing circuitry, the encoded CSI feedback and assistance data indicating the propagation condition to a base station.

Example 22 may include the method of example 21 and/or any other example herein, wherein the assistance data indicating the propagation condition is based on a contrast ratio of a channel matrix in an angular-delay domain.

Example 23 may include the method of example 21 and/or any other example herein, wherein selecting the encoder model and the encoder output configuration is further based on a CSI-AutoencoderConfigPolicy information element received from the base station, the CSI-AutoencoderConfigPolicy information element comprising an autoencoder configuration policy identifier and a list of autoencoder configurations where each autoencoder configuration is a combination of assistance data that indicate a respective propagation condition, and an encoder model and an encoder output configuration that should be applied under the propagation condition.

Example 24 may include an apparatus comprising means for providing, to a user equipment (UE) device, a CSI autoencoder configuration policy defining which encoder model from among multiple encoder models to select and which encoder output configuration from among multiple encoder output configurations to select under a specific propagation condition experienced by the UE device; providing, to the UE device, a CSI report configuration to apply to a CSI report; providing, to the UE device, in the CSI report configuration, an autoencoder configuration policy to apply to a CSI feedback report; detecting an encoded CSI feedback report and an assistance data indicating a propagation condition, received from the UE device, indicating an encoder model and an encoder output configuration used in a CSI feedback report from the UE device; and decoding, based on the autoencoder configuration policy, a CSI feedback report from the encoded CSI feedback report, wherein the CSI feedback report comprises both encoded CSI feedback and assistance data indicating the propagation condition, received from the UE device, wherein the CSI feedback report is based on the CSI report configuration.

Example 25 may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Example 26 may include an apparatus comprising logic, modules, and/or circuitry to perform one or more elements of a method described in or related to any of examples 1-24, or any other method or process described herein.

Example 27 may include a method, technique, or process as described in or related to any of examples 1-24, or portions or parts thereof.

Example 28 may include an apparatus comprising: one or more processors and one or more computer readable media comprising instructions that, when executed by the one or more processors, cause the one or more processors to perform the method, techniques, or process as described in or related to any of examples 1-24, or portions thereof.

Example 29 may include a method of communicating in a wireless network as shown and described herein.

Example 30 may include a system for providing wireless communication as shown and described herein.

Example 31 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019-06) and/or any other 3GPP standard. For the purposes of the present document, the following abbreviations (shown in Table 5) may apply to the examples and embodiments discussed herein.

TABLE 5
Abbreviations

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACK | Acknowledgement |
| ACID | Application Client |
| | Identification |
| AF | Application Function |
| AM | Acknowledged Mode |
| AMBR | Aggregate Maximum Bit |
| | Rate |
| AMF | Access and Mobility |
| | Management Function |
| AN | Access Network |
| ANR | Automatic Neighbour |
| | Relation |
| AP | Application Protocol, |
| | Antenna Port, Access |
| | Point |
| API | Application Programming |
| | Interface |
| APN | Access Point Name |
| ARP | Allocation and Retention |
| | Priority |
| ARQ | Automatic Repeat Request |
| AS | Access Stratum |
| ASP | Application Service |
| | Provider |
| ASN.1 | Abstract Syntax Notation |
| | One |
| AUSF | Authentication Server |
| | Function |
| AWGN | Additive White Gaussian |
| | Noise |
| BAP | Backhaul Adaptation |
| | Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote |
| | Access Server |
| BSS | Business Support System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital EXpenditure |
| CBRA | Contention Based Random |
| | Access |
| CC | Component Carrier, |
| | Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple |
| | Access |
| CFRA | Contention Free Random |
| | Access |
| CG | Cell Group |
| CGF | Charging Gateway |
| | Function |
| CHF | Charging Function |
| CI | Cell Identity |
| CID | Cell-ID (e.g., positioning |
| | method) |
| CIM | Common Information |
| | Model |
| CIR | Carrier to Interference |
| | Ratio |
| CK | Cipher Key |
| CM | Connection Management, |
| | Conditional Mandatory |
| CMAS | Commercial Mobile Alert |
| | Service |
| CMD | Command |
| CMS | Cloud Management |
| | System |
| CO | Conditional Optional |
| COMP | Coordinated Multi-Point |
| CORESET | Control Resource Set |
| COTS | Commercial Off-The- |
| | Shelf |
| CP | Control Plane, Cyclic |
| | Prefix, Connection Point |
| CPD | Connection Point |
| | Descriptor |
| CPE | Customer Premise |
| | Equipment |
| CPICH | Common Pilot Channel |
| CQI | Channel Quality Indicator |
| CPU | CSI processing unit, |
| | Central Processing Unit |
| C/R | Command/Response field |
| | bit |
| CRAN | Cloud Radio Access |
| | Network, Cloud RAN |
| CRB | Common Resource Block |
| CRC | Cyclic Redundancy Check |
| CRI | Channel-State Information |
| | Resource Indicator, CSI- |
| | RS Resource Indicator |
| C-RNTI | Cell RNTI |
| CS | Circuit Switched |
| CSAR | Cloud Service Archive |
| CSI | Channel-State Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise and |
| | interference ratio |
| CSMA | Carrier Sense Multiple |
| | Access |
| CSMA/CA | CSMA with collision |
| | avoidance |
| CSS | Common Search Space, |
| | Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct |
| | Current |
| DCI | Downlink Control |
| | Information |
| DF | Deployment Flavour |
| DL | Downlink |
| DMTF | Distributed Management |
| | Task Force |
| DPDK | Data Plane Development |
| | Kit |
| DM-RS, | Demodulation |
| DMRS | Reference Signal |
| DN | Data network |
| DNN | Data Network Name |
| DNAI | Data Network Access |
| | Identifier |
| DRB | Data Radio Bearer |
| DRS | Discovery Reference |
| | Signal |
| DRX | Discontinuous Reception |
| DSL | Domain Specific |
| | Language. Digital |
| | Subscriber Line |
| DSLAM | DSL Access Multiplexer |
| DwPTS | Downlink Pilot Time Slot |
| E-LAN | Ethernet Local Area |
| | Network |
| E2E | End-to-End |
| ECCA | extended clear channel |
| | assessment, extended |
| | CCA |
| ECCE | Enhanced Control |
| | Channel Element, |
| | Enhanced CCE |
| ED | Energy Detection |
| EDGE | Enhanced Datarates for |
| | GSM Evolution (GSM |
| | Evolution) |
| EAS | Edge Application Server |
| EASID | Edge Application Server |
| | Identification |
| ECS | Edge Configuration Server |
| ECSP | Edge Computing Service |
| | Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge Hosting |
| | Environment |
| EGMF | Exposure Governance |
| | tableManagement |
| | Function |
| EGPRS | Enhanced GPRS |
| EIR | Equipment Identity |
| | Register |
| eLAA | enhanced Licensed |
| | Assisted Access, enhanced |
| | LAA |
| EM | Element Manager |
| eMBB | Enhanced Mobile |
| | Broadband |
| EMS | Element Management |
| | System |
| eNB | evolved NodeB, E- |
| | UTRAN Node B |
| EN-DC | E-UTRA-NR Dual |
| | Connectivity |
| EPC | Evolved Packet Core |
| EPDCCH | enhanced PDCCH, |
| | enhanced Physical |
| | Downlink Control Cannel |
| EPRE | Energy per resource |
| | element |
| EPS | Evolved Packet System |
| EREG | enhanced REG, enhanced |
| | resource element groups |
| ETSI | European |
| | Telecommunications |
| | Standards Institute |
| ETWS | Earthquake and Tsunami |
| | Warning System |
| eUICC | embedded UICC, |
| | embedded Universal |
| | Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access Channel |
| FAUSCH | Fast Uplink Signalling |
| | Channel |
| FB | Functional Block |
| FBI | Feedback Information |
| FCC | Federal Communications |
| | Commission |
| FCCH | Frequency Correction |
| | CHannel |
| FDD | Frequency Division |
| | Duplex |
| FDM | Frequency Division |
| | Multiplex |
| FDMA | Frequency Division |
| | Multiple Access |
| FE | Front End |
| FEC | Forward Error Correction |
| FFS | For Further Study |
| FFT | Fast Fourier |
| | Transformation |
| feLAA | further enhanced Licensed |
| | Assisted Access, further |
| | enhanced LAA |
| FN | Frame Number |
| FPGA | Field-Programmable Gate |
| | Array |
| FR | Frequency Range |
| FQDN | Fully Qualified Domain |
| | Name |
| G-RNTI | GERAN Radio Network |
| | Temporary Identity |
| GERAN | GSM EDGE RAN, GSM |
| | EDGE Radio Access |
| | Network |
| GGSN | Gateway GPRS Support |
| | Node |
| GLONASS | GLObal'naya |
| | NAvigatsionnaya |
| | Sputnikovaya Sistema |
| | (Engl.: Global Navigation |
| | Satellite System) |
| gNB | Next Generation NodeB |
| gNB-CUg | NB-centralized unit, Next |
| | Generation NodeB |
| | centralized unit |
| gNB-DU | gNB-distributed unit, Next |
| | Generation NodeB |
| | distributed unit |
| GNSS | Global Navigation |
| | Satellite System |
| GPRS | General Packet Radio |
| | Service |
| GPSI | Generic Public |
| | Subscription Identifier |
| GSM | Global System for Mobile |
| | Communications, Groupe |
| | Special Mobile |
| GTP | GPRS Tunneling Protocol |
| GTP-U | GPRS Tunnelling Protocol |
| | for User Plane |
| GTS | Go To Sleep Signal |
| | (related to WUS) |
| GUMMEI | Globally Unique MME |
| | Identifier |
| GUTI | Globally Unique |
| | Temporary UE Identity |
| HARQ | Hybrid ARQ, Hybrid |
| | Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile |
| | Network |
| HSDPA | High Speed Downlink |
| | Packet Access |
| HSN | Hopping Sequence |
| | Number |
| HSPA | High Speed Packet Access |
| HSS | Home Subscriber Server |
| HSUPA | High Speed Uplink Packet |
| | Access |
| HTTP | Hyper Text Transfer |
| | Protocol |
| HTTPS | Hyper Text Transfer |
| | Protocol Secure (https is |
| | http/1.1 over SSL, i.e. port |
| | 443) |
| I-Block | Information Block |
| ICCID | Integrated Circuit Card |
| | Identification |
| IAB | Integrated Access and |
| | Backhaul |
| ICIC | Inter-Cell Interference |
| | Coordination |
| ID | Identity, identifier |
| IDFT | Inverse Discrete Fourier |
| | Transform |
| IE | Information element |
| IBE | In-Band Emission |
| IEEE | Institute of Electrical |
| | and Electronics |
| | Engineers |
| IEI | Information Element |
| | Identifier |
| IEIDL | Information Element |
| | Identifier Data Length |
| IETF | Internet Engineering |
| | Task Force |
| IF | Infrastructure |
| IM | Interference |
| | Measurement, |
| | Intermodulation, IP |
| | Multimedia |
| IMC | IMS Credentials |
| IMEI | International Mobile |
| | Equipment Identity |
| IMGI | International mobile |
| | group identity |
| IMPI | IP Multimedia Private |
| | Identity |
| IMPU | IP Multimedia PUblic |
| | identity |
| IMS | IP Multimedia |
| | Subsystem |
| IMSI | International Mobile |
| | Subscriber Identity |
| IoT | Internet of Things |
| IP | Internet Protocol |
| Ipsec | IP Security, Internet |
| | Protocol Security |
| IP-CAN | IP-Connectivity |
| | Access Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration Reference |
| | Point |
| ISDN | Integrated Services |
| | Digital Network |
| ISIM | IM Services Identity |
| | Module |
| ISO | International |
| | Organisation for |
| | Standardisation |
| ISP | Internet Service |
| | Provider |
| IWF | Interworking-Function |
| I-WLAN | Interworking WLAN |
| | Constraint length of the |
| | convolutional code, USIM |
| | Individual key |
| kB | Kilobyte (1000 bytes) |
| kbps | kilo-bits per second |
| Kc | Ciphering key |
| Ki | Individual subscriber |
| | authentication key |
| KPI | Key Performance |
| | Indicator |
| KQI | Key Quality Indicator |
| KSI | Key Set Identifier |
| ksps | kilo-symbols per |
| | second |
| KVM | Kernel Virtual |
| | Machine |
| L1 | Layer 1 (physical |
| | layer) |
| L1-RSRP | Layer 1 reference |
| | signal received power |
| L2 | Layer 2 (data link |
| | layer) |
| L3 | Layer 3 (network |
| | layer) |
| LAA | Licensed Assisted |
| | Access |
| LAN | Local Area Network |
| LADN | Local Area Data |
| | Network |
| LBT | Listen Before Talk |
| LCM | LifeCycle |
| | Management |
| LCR | Low Chip Rate |
| LCS | Location Services |
| LCID | Logical Channel ID |
| LI | Layer Indicator |
| LLC | Logical Link Control, |
| | Low Layer |
| | Compatibility |
| LPLMN | Local PLMN |
| LPP | LTE Positioning |
| | Protocol |
| LSB | Least Significant Bit |
| LTE | Long Term Evolution |
| LWA | LTE-WLAN |
| | aggregation |
| LWIP | LTE/WLAN Radio |
| | Level Integration with |
| | IPsec Tunnel |
| LTE | Long Term Evolution |
| M2M | Machine-to-Machine |
| MAC | Medium Access |
| | Control (protocol |
| | layering context) |
| MAC | Message authentication |
| | code |
| | (security/encryption |
| | context) |
| MAC-A | MAC used for |
| | authentication and key |
| | agreement (TSG T |
| | WG3 context) |
| MAC-I | MAC used for data |
| | integrity of signalling |
| | messages (TSG T |
| | WG3 context) |
| MANO | Management and |
| | Orchestration |
| MBMS | Multimedia Broadcast |
| | and Multicast Service |
| MBSFN | Multimedia Broadcast |
| | multicast service |
| | Single Frequency |
| | Network |
| MCC | Mobile Country Code |
| MCG | Master Cell Group |
| MCOT | Maximum Channel |
| | Occupancy Time |
| MCS | Modulation and coding |
| | scheme |
| MDAF | Management Data |
| | Analytics Function |
| MDAS | Management Data |
| | Analytics Service |
| MDT | Minimization of Drive |
| | Tests |
| ME | Mobile Equipment |
| MeNB | master eNB |
| MER | Message Error Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input |
| | Multiple Output |
| MLC | Mobile Location |
| | Centre |
| MM | Mobility Management |
| MME | Mobility Management |
| | Entity |
| MN | Master Node |
| MNO | Mobile Network |
| | Operator |
| MO | Measurement Object, |
| | Mobile Originated |
| MPBCH | MTC Physical |
| | Broadcast CHannel |
| MPDCCH | MTC Physical |
| | Downlink Control |
| | CHannel |
| MPDSCH | MTC Physical |
| | Downlink Shared |
| | CHannel |
| MPRACH | MTC Physical |
| | Random Access |
| | CHannel |
| MPUSCH | MTC Physical Uplink |
| | Shared Channel |
| MPLS | MultiProtocol Label |
| | Switching |
| MS | Mobile Station |
| MSB | Most Significant Bit |
| MSC | Mobile Switching |
| | Centre |
| MSI | Minimum System |
| | Information, MCH |
| | Scheduling |
| | Information |
| MSID | Mobile Station |
| | Identifier |
| MSIN | Mobile Station |
| | Identification Number |
| MSISDN | Mobile Subscriber |
| | ISDN Number |
| MT | Mobile Terminated, |
| | Mobile Termination |
| MTC | Machine-Type |
| | Communications |
| mMTC | massive MTC, massive |
| | Machine-Type |
| | Communications |
| MU-MIMO | Multi User MIMO |
| MWUS | MTC wake-up signal, |
| | MTC WUS |
| NACK | Negative |
| | Acknowledgement |
| NAI | Network Access |
| | Identifier |
| NAS | Non-Access Stratum, |
| | Non-Access Stratum |
| | layer |
| NCT | Network Connectivity |
| | Topology |
| NC-JT | Non-Coherent Joint |
| | Transmission |
| NEC | Network Capability |
| | Exposure |
| NE-DC | NR-E-UTRA Dual |
| | Connectivity |
| NEF | Network Exposure |
| | Function |
| NF | Network Function |
| NFP | Network Forwarding |
| | Path |
| NFPD | Network Forwarding |
| | Path Descriptor |
| NFV | Network Functions |
| | Virtualization |
| NFVI | NFV Infrastructure |
| NFVO | NFV Orchestrator |
| NG | Next Generation, Next |
| | Gen |
| NGEN-DC | NG-RAN E-UTRA- |
| | NR Dual Connectivity |
| NM | Network Manager |
| NMS | Network Management |
| | System |
| N-PoP | Network Point of |
| | Presence |
| NMIB, N-MIB | Narrowband MIB |
| NPBCH | Narrowband Physical |
| | Broadcast CHannel |
| NPDCCH | Narrowband Physical |
| | Downlink Control |
| | CHannel |
| NPDSCH | Narrowband Physical |
| | Downlink Shared |
| | CHannel |
| NPRACH | Narrowband Physical |
| | Random Access |
| | CHannel |
| NPUSCH | Narrowband Physical |
| | Uplink Shared |
| | CHannel |
| NPSS | Narrowband Primary |
| | Synchronization Signal |
| NSSS | Narrowband |
| | Secondary |
| | Synchronization Signal |
| NR | New Radio, Neighbour |
| | Relation |
| NRF | NF Repository |
| | Function |
| NRS | Narrowband Reference |
| | Signal |
| NS | Network Service |
| NSA | Non-Standalone |
| | operation mode |
| NSD | Network Service |
| | Descriptor |
| NSR | Network Service |
| | Record |
| NSSAI | Network Slice |
| | Selection Assistance |
| | Information |
| S-NNSAI | Single-NSSAI |
| | Control |
| NSSF | Network Slice |
| | Selection Function |
| NW | Network |
| NWUS | Narrowband wake-up |
| | signal, Narrowband |
| | WUS |
| NZP | Non-Zero Power |
| O&M | Operation and |
| | Maintenance |
| ODU2 | Optical channel Data |
| | Unit-type 2 |
| OFDM | Orthogonal Frequency |
| | Division Multiplexing |
| OFDMA | Orthogonal Frequency |
| | Division Multiple |
| | Access |
| OOB | Out-of-band |
| OOS | Out of Sync |
| OPEX | OPerating EXpense |
| OSI | Other System |
| | Information |
| OSS | Operations Support |
| | System |
| OTA | over-the-air |
| PAPR | Peak-to-Average |
| | Power Ratio |
| PAR | Peak to Average Ratio |
| PBCH | Physical Broadcast |
| | Channel |
| PC | Power Control, |
| | Personal Computer |
| PCC | Primary Component |
| | Carrier, Primary CC |
| PCell | Primary Cell |
| PCI | Physical Cell ID, |
| | Physical Cell Identity |
| PCEF | Policy and Charging |
| | Enforcement Function |
| PCF | Policy Control |
| | Function |
| PCRF | Policy Control and |
| | Charging Rules |
| | Function |
| PDCP | Packet Data |
| | Convergence Protocol, |
| | Packet Data |
| | Convergence Protocol |
| | layer |
| PDCCH | Physical Downlink |
| | Control Channel |
| PDCP | Packet Data |
| | Convergence Protocol |
| PDN | Packet Data Network, |
| | Public Data Network |
| PDSCH | Physical Downlink |
| | Shared Channel |
| PDU | Protocol Data Unit |
| PEI | Permanent Equipment |
| | Identifiers |
| PFD | Packet Flow |
| | Description |
| P-GW | PDN Gateway |
| PHICH | Physical hybrid-ARQ |
| | indicator channel |
| PHY | Physical layer |
| PLMN | Public Land Mobile |
| | Network |
| PIN | Personal Identification |
| | Number |
| PM | Performance |
| | Measurement |
| PMI | Precoding Matrix |
| | Indicator |
| PNF | Physical Network |
| | Function |
| PNFD | Physical Network |
| | Function Descriptor |
| PNFR | Physical Network |
| | Function Record |
| POC | PTT over Cellular |
| PP, PTP | Point-to-Point |
| PPP | Point-to-Point Protocol |
| PRACH | Physical RACH |
| PRB | Physical resource |
| | block |
| PRG | Physical resource |
| | block group |
| ProSe | Proximity Services, |
| | Proximity-Based |
| | Service |
| PRS | Positioning Reference |
| | Signal |
| PRR | Packet Reception |
| | Radio |
| PS | Packet Services |
| PSBCH | Physical Sidelink |
| | Broadcast Channel |
| PSDCH | Physical Sidelink |
| | Downlink Channel |
| PSCCH | Physical Sidelink |
| | Control Channel |
| PSSCH | Physical Sidelink |
| | Shared Channel |
| PSCell | Primary SCell |
| PSS | Primary |
| | Synchronization Signal |
| PSTN | Public Switched |
| | Telephone Network |
| PT-RS | Phase-tracking |
| | reference signal |
| PTT | Push-to-Talk |
| PUCCH | Physical Uplink |
| | Control Channel |
| PUSCH | Physical Uplink Shared |
| | Channel |
| QAM | Quadrature Amplitude |
| | Modulation |
| QCI | QoS class of identifier |
| QCL | Quasi co-location |
| QFI | QoS Flow ID, QoS |
| | Flow Identifier |
| QoS | Quality of Service |
| QPSK | Quadrature |
| | (Quaternary) Phase |
| | Shift Keying |
| QZSS | Quasi-Zenith Satellite |
| | System |
| RA-RNTI | Random Access RNTI |
| RAB | Radio Access Bearer, |
| | Random Access Burst |
| RACH | Random Access |
| | Channel |
| RADIUS | Remote Authentication |
| | Dial In User Service |
| RAN | Radio Access Network |
| RAND | RANDom number |
| | (used for |
| | authentication) |
| RAR | Random Access Response |
| RAT | Radio Access |
| | Technology |
| RAU | Routing Area Update |
| RB | Resource block, Radio |
| | Bearer |
| RBG | Resource block group |
| REG | Resource Element |
| | Group |
| Rel | Release |
| REQ | REQuest |
| RF | Radio Frequency |
| RI | Rank Indicator |
| RIV | Resource indicator |
| | value |
| RL | Radio Link |
| RLC | Radio Link Control, |
| | Radio Link Control |
| | layer |
| RLC AM | RLC Acknowledged |
| | Mode |
| RLC UM | RLC Unacknowledged |
| | Mode |
| RLF | Radio Link Failure |
| RLM | Radio Link Monitoring |
| RLM-RS | Reference Signal for |
| | RLM |
| RM | Registration |
| | Management |
| RMC | Reference |
| | Measurement Channel |
| RMSI | Remaining MSI, |
| | Remaining Minimum |
| | System Information |
| RN | Relay Node |
| RNC | Radio Network |
| | Controller |
| RNL | Radio Network Layer |
| RNTI | Radio Network |
| | Temporary Identifier |
| ROHC | RObust Header |
| | Compression |
| RRC | Radio Resource |
| | Control, Radio |
| | Resource Control layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal Time |
| | difference |
| RTP | Real Time Protocol |
| RTS | Ready-To-Send |
| RTT | Round Trip Time |
| Rx | Reception, Receiving, |
| | Receiver |
| S1AP | S1 Application |
| | Protocol |
| S1-MME | S1 for the control plane |
| S1-U | S1 for the user plane |
| S-GW | Serving Gateway |
| S-RNTI | SRNC Radio Network |
| | Temporary Identity |
| S-TMSI | SAE Temporary |
| | Mobile Station |
| | Identifier |
| SA | Standalone operation |
| | mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary Component |
| | Carrier, Secondary CC |
| SCell | Secondary Cell |
| SCEF | Service Capability |
| | Exposure Function |
| SC-FDMA | Single Carrier |
| | Frequency Division |
| | Multiple Access |
| SCG | Secondary Cell Group |
| SCM | Security Context |
| | Management |
| SCS | Subcarrier Spacing |
| SCTP | Stream Control |
| | Transmission Protocol |
| SDAP | Service Data |
| | Adaptation Protocol, |
| | Service Data |
| | Adaptation Protocol |
| | layer |
| SDL | Supplementary |
| | Downlink |
| SDNF | Structured Data |
| | Storage Network |
| | Function |
| SDP | Session Description |
| | Protocol |
| SDSF | Structured Data |
| | Storage Function |
| SDU | Service Data Unit |
| SEAF | Security Anchor |
| | Function |
| SeNB | secondary eNB |
| SEPP | Security Edge |
| | Protection Proxy |
| SFI | Slot format indication |
| SFTD | Space-Frequency Time |
| | Diversity, SFN and |
| | frame timing difference |
| SFN | System Frame Number |
| SgNB | Secondary gNB |
| SGSN | Serving GPRS Support |
| | Node |
| S-GW | Serving Gateway |
| SI | System Information |
| SI-RNTI | System Information |
| | RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level |
| | Agreement |
| SM | Session Management |
| SMF | Session Management |
| | Function |
| SMS | Short Message Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| | SpCell Special Cell |
| SP-CSI-RNTI | Semi-Persistent |
| | CSI RNTI |
| | SPS Semi-Persistent |
| | Scheduling |
| SQN | Sequence number |
| SR | Scheduling Request |
| SRB | Signalling Radio |
| | Bearer |
| SRS | Sounding Reference |
| | Signal |
| SS | Synchronization Signal |
| SSB | Synchronization Signal |
| | Block |
| SSID | Service Set Identifier |
| SS/PBCH | Block |
| SSBRI | SS/PBCH Block |
| | Resource Indicator, |
| | Synchronization Signal |
| | Block Resource |
| | Indicator |
| SSC | Session and Service |
| | Continuity |
| SS-RSRP | Synchronization Signal |
| | based Reference Signal |
| | Received Power |
| SS-RSRQ | Synchronization Signal |
| | based Reference Signal |
| | Received Quality |
| SS-SINR | Synchronization Signal |
| | based Signal to Noise |
| | and Interference Ratio |
| SSS | Secondary |
| | Synchronization Signal |
| SSSG | Search Space Set |
| | Group |
| SSSIF | Search Space Set |
| | Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission |
| | Configuration Indicator |
| TCP | Transmission |
| | Communication |
| | Protocol |
| TDD | Time Division Duplex |
| TDM | Time Division |
| | Multiplexing |
| TDMA | Time Division Multiple |
| | Access |
| TE | Terminal Equipment |
| TEID | Tunnel End Point |
| | Identifier |
| TFT | Traffic Flow Template |
| TMSI | Temporary Mobile |
| | Subscriber Identity |
| TNL | Transport Network |
| | Layer |
| TPC | Transmit Power |
| TPMI | Transmitted Precoding |
| | Matrix Indicator |
| TR | Technical Report |
| TRP, TRxP | Transmission |
| | Reception Point |
| TRS | Tracking Reference |
| | Signal |
| TRx | Transceiver |
| TS | Technical |
| | Specifications. |
| | Technical Standard |
| TTI | Transmission Time |
| | Interval |
| Tx | Transmission, |
| | Transmitting, |
| | Transmitter |
| U-RNTI | UTRAN Radio |
| | Network Temporary |
| | Identity |
| UART | Universal |
| | Asynchronous |
| | Receiver and |
| | Transmitter |
| UCI | Uplink Control |
| | Information |
| UE | User Equipment |
| UDM | Unified Data |
| | Management |
| UDP | User Datagram |
| | Protocol |
| UDSF | Unstructured Data |
| | Storage Network |
| | Function |
| UICC | Universal Integrated |
| | Circuit Card |
| UL | Uplink |
| UM | Unacknowledged |
| | Mode |
| UML | Unified Modelling |
| | Language |
| UMTS | Universal Mobile |
| | Telecommunications |
| | System |
| UP | User Plane |
| UPF | User Plane Function |
| URI | Uniform Resource |
| | Identifier |
| URL | Uniform Resource |
| | Locator |
| URLLC | Ultra-Reliable and Low |
| | Latency |
| USB | Universal Serial Bus |
| USIM | Universal Subscriber |
| | Identity Module |
| USS | UE-specific search |
| | space |
| UTRA | UMTS Terrestrial |
| | Radio Access |
| UTRAN | Universal Terrestrial |
| | Radio Access Network |
| UwPTS | Uplink Pilot Time Slot |
| V2I | Vehicle-to- |
| | Infrastruction |
| V2P | Vehicle-to-Pedestrian |
| V2V | Vehicle-to-Vehicle |
| V2X | Vehicle-to-everything |
| VIM | Virtualized |
| | Infrastructure Manager |
| VL | Virtual Link, |
| VLAN | Virtual LAN, Virtual |
| | Local Area Network |
| VM | Virtual Machine |
| VNF | Virtualized Network |
| | Function |
| VNFFG | VNF Forwarding |
| | Graph |
| VNFFGD | VNF Forwarding |
| | Graph Descriptor |
| VNFM | VNF Manager |
| VoIP | Voice-over-IP, Voice- |
| | over-Internet Protocol |
| VPLMN | Visited Public Land |
| | Mobile Network |
| VPN | Virtual Private |
| | Network |
| VRB | Virtual Resource Block |
| WiMAX | Worldwide |
| | Interoperability for |
| | Microwave Access |
| WLAN | Wireless Local Area |
| | Network |
| WMAN | Wireless Metropolitan |
| | Area Network |
| WPAN | Wireless Personal Area |
| | Network |
| X2-C | X2-Control plane |
| X2-U | X2-User plane |
| XML | eXtensible Markup |
| | Language |
| XRES | EXpected user |
| | RESponse |
| XOR | eXclusive OR |
| ZC | Zadoff-Chu |
| ZP | Zero Po |

What is claimed is:

1-25. (canceled)

26. A user equipment (UE) device for adjusting an encoder model and an encoder output configuration, the UE device comprising processing circuitry coupled to storage for storing information associated with the encoder model and encoder output configuration, the processing circuitry configured to:
select an encoder model based on a propagation condition;
select an encoder output configuration based on the propagation condition;
encode, using the encoder model and the encoder output configuration, channel state information (CSI) feedback indicative of channel state information; and
provide, the encoded CSI feedback and a signal that indicates the propagation condition to a base station.

27. The UE device of claim 26, wherein the propagation condition is based on a contrast ratio of a channel matrix in an angular-delay domain.

28. The UE device of claim 26, wherein to select the encoder model and the encoder output configuration is further based on a CSI-AutoencoderConfigPolicy information element received from the base station, the CSI-AutoencoderConfigPolicy information element comprising an autoencoder configuration policy identifier and a list of autoencoder configurations, wherein each autoencoder configuration is a combination of assistance data that indicates a respective propagation condition, and an encoder model and an encoder output configuration that should be applied under the propagation condition.

29. The UE device of claim 28, wherein the list of autoencoder configurations is further defined based on an autoencoderConfigList information element received from the base station, the autoencoderConfigList information element defining a list of autoencoder configurations to apply based on a policy indicated by the CSI-AutoencoderConfigPolicy information element.

30. The UE device of claim 29, wherein each autoencoder configuration within the list of autoencoder configurations is further based on an autoencoderConfig information element received from the base station, the autoencoderConfig information element comprising an assistance data field that reflects propagation condition, an encoder model identifier field, and an encoder output configuration field, and wherein the assistance data field signals that the UE device is to apply the encoder model as specified by the encoder model identifier field and the encoder output configuration as specified by the encoder model identifier field under the propagation condition defined by the assistance data field.

31. The UE device of claim 30, wherein the assistance data field signals that the UE device is to apply a specific encoder model and a specific encoder output configuration based on a line-of-sight (LOS)/non-LOS (NLOS) state, and wherein the LOS/NLOS state indicates that whether a link from the UE device to the base station is LOS or non-LOS.

32. The UE device of claim 31, wherein the LOS/NLOS state is further defined by LOS-NLOS-State information element received from the base station, the LOS-NLOS-State information element comprising either a hard LOS/NLOS state or an interval of a soft LOS/NLOS state indicating a probability of the link between the UE device and the base station being LOS.

33. The UE device of claim 32, wherein the interval of a soft LOS/NLOS state is further defined by a Soft-LOS-NLOS-Range information element comprising a Soft-LOS-NLOS-Range identifier, a lower bound of the soft LOS/NLOS state, and an upper bound of the soft LOS/NLOS state.

34. The UE device of claim 30, wherein the assistance data field signals that the UE device is to apply a specific encoder model and a specific encoder output configuration is based on a contrast ratio (CR) range, and wherein the processing circuitry is further configured to modify encoder model and encoder output configuration based on the CR range.

35. The UE device of claim 34, wherein a CR-Range information element received from the base station defines a CR interval of the CR and comprises a CR range identifier, a lower bound of the CR range, and an upper bound of the CR range.

36. The UE device of claim 26, wherein the processing circuitry is further configured to:
encode, using the encoder model and the encoder output configuration, second CSI feedback indicative of a second channel state information; and
provide the second encoded CSI feedback and second assistance data indicating the propagation condition to the base station.

37. The UE device of claim 26, wherein to provide a CSI report that includes the encoded CSI feedback and the signal that indicates the propagation condition to the base station using a first autoencoder configuration policy for the encoded CSI feedback and the signal that indicates the propagation condition, wherein the processing circuitry is further configured to provide second CSI report that includes second encoded CSI feedback and second assistance data indicating the propagation condition to the base station using a second autoencoder configuration policy, and wherein the UE device receives the first autoencoder configuration policy and the second autoencoder configuration policy from the base station.

38. The UE device of claim 37, wherein a first CSI-ReportConfig information element of the CSI report configuration received by the UE device from the base station signals a first autoencoderConfigPolicyld to identify the first autoencoder configuration policy, and wherein a second CSI-ReportConfig information element of the second CSI report configuration signals a second autoencoderConfigPolicyId to identify the second autoencoder configuration policy.

39. The UE device of claim 26, wherein to provide the encoded CSI feedback to the base station comprises to signal assistance data indicating the propagation condition to the base station, the assistance data indicative of the encoder model and encoder output configuration selected by the UE device.

40. The UE device of claim 39, wherein the assistance data indicating the propagation condition indicates a LOS or NLOS state.

41. The UE device of claim 39, wherein the assistance data indicating the propagation condition is indicated by a range signaled by a LOS or NLOS range identifier.

42. The UE device of claim 39, where in the assistance data indicating the propagation condition indicates a CR range signaled by a CR range identifier.

43. A non-transitory computer-readable storage medium comprising instructions to cause processing circuitry of a base station for adjusting an encoder model and an encoder output configuration, upon execution of the instructions by the processing circuitry, to:
provide, to a user equipment (UE) device, a CSI autoencoder configuration policy defining which encoder model from among multiple encoder models to select and which encoder output configuration from among multiple encoder output configurations to select under a specific propagation condition experienced by the UE device;
provide, to the UE device, a CSI report configuration to apply to a CSI report;
provide, to the UE device, in the CSI report configuration, an autoencoder configuration policy to apply to a CSI feedback report;
detect an encoded CSI feedback report and an assistance data indicating a propagation condition, received from the UE device, indicating an encoder model and an encoder output configuration used in a CSI feedback report from the UE device; and
decode, based on the autoencoder configuration policy, a CSI feedback report from the encoded CSI feedback report, wherein the CSI feedback report comprises both encoded CSI feedback and assistance data indicating the propagation condition, received from the UE device, wherein the CSI feedback report is based on the CSI report configuration.

44. The non-transitory computer-readable storage medium of claim 43, wherein the assistance data indicating the propagation condition comprises a line-of-sight (LOS)/non-LOS (NLOS) state identifier.

45. A method for adjusting an encoder model and an encoder output configuration, the method comprising:
selecting, by processing circuitry of a user equipment (UE) device, an encoder model based on a propagation condition;
selecting, by the processing circuitry, an encoder output configuration based on the propagation condition;
encoding, by the processing circuitry, using the encoder model and encoder output configuration, CSI feedback indicative of channel state information; and
providing, by the processing circuitry, the encoded CSI feedback and assistance data indicating the propagation condition to a base station.
